(19) United States
(12) Patent Application Publication
(10) Pub. No.: US 2013/0335509 A1
(43) Pub. Date: Dec. 19, 2013

(54) METHODS, SYSTEMS, AND ARTICLES OF MANUFACTURE FOR ONLINE VIDEO DATING

(71) Applicant: Marcel CAFFERATA, SAN JOSE, CA (US)

(72) Inventor: Marcel CAFFERATA, SAN JOSE, CA (US)

(73) Assignee: MOBILE VIDEO DATE, INC., SAN JOSE, CA (US)

(21) Appl. No.: 13/526,475

(22) Filed: Jun. 18, 2012

(51) Int. Cl. H04N 7/15

(52) U.S. Cl. 348/14.08; 348/E07.083

(57) ABSTRACT

Disclosed is a method, system, and article of manufacture for implementing online video date that identifies a list of potential dates for a requesting user based on the requesting user's preferences or criteria, the personal data of the requesting user, or the personal data of a potential date. The method or system examines the registered users against the requesting user's preferences or criteria, the personal data of the requesting user, or the personal data of or other data related to the registered users to identify the list of potential dates from the registered users. The requesting user may identify one or more potential dates from the list and initiate online video date with the one or more potential dates. The method or system may also provide other applications or services concurrently with the provisioning of online video date.

### BACKGROUND

The Internet is a global system of interconnected computer networks that use the standard Internet protocol suite (often called TCP/IP, although not all applications use TCP) to serve billions of users worldwide. The Internet carries an extensive range of information resources and services, such as the inter-linked hypertext documents of the World Wide Web (WWW) and the infrastructure to support email. The communications infrastructure of the Internet consists of its hardware components and a system of software layers that control various aspects of the architecture.

Online dating or Internet dating is a dating service or system that allows individuals, couples, and groups to make contact and communicate with each other over the Internet, usually with the objective of developing a personal, romantic, or sexual relationship. Online dating services usually provide un-moderated matchmaking over the Internet, through the use of personal computers or mobile computing devices. Conventional Internet dating products or services rely on static information such as textual information, images, etc. or some more dynamic information such as some messaging services for users that are remotely connected via the Internet.

Therefore, there is a need for a method, system, and computer program product for online video dating.

### SUMMARY

Disclosed are various embodiments of methods, systems, and articles of manufactures for online dating. In various embodiments, the method or system uses a computing device, which may comprise, for example but not limited to, a mobile phone, a desktop computer, a laptop computer, a nettop computer, a tablet, a terminal, a workstation, a server, a mobile, internet-enabled device (e.g., an e-book reader or a music player capable of connecting to the Internet), or any other computing devices (hereinafter computing device collectively) that may be used to perform various functions as described herein, to identify one or more user's preferences or one or more user-defined criteria. In one or more embodiments, the method or system may further uses the computing device to identify one or more user characteristics in various forms and store the identified one or more user characteristics.

In one or more embodiments, the method or the system may use the computing device to store the one or more preferences, one or more criteria, one or more characteristics, or any combinations thereof in a non-transitory computer readable storage medium. In one or more embodiments, the method or the system may use the computing device to identify a list of registered users based at least in part upon the one or more preferences, one or more criteria, one or more characteristics, or any combinations thereof. In some embodiments, a registered user is one who has been registered to use the online dating products or services. In some embodiments, a registered user is a registered user who has explicitly agreed to participate in the online video dating products or services of the online dating products or services by, for example but not limited to, explicitly agreeing to the terms, conditions, and policies and to participating in the online dating services. Unless otherwise explicitly specified, a registered user and a registered user are used interchangeably in this application to represent a user who has explicitly agreed to participate in the online video dating products or services of the online dating products or services.

In one or more embodiments, the method or system may further uses the computing device to present a list of registered users to a requesting user either randomly or in a certain order controlled by the requesting user. In one or more embodiments, the method or system may further uses the computing device to identify an input that identifies one or more particular registered users, with whom the requesting user wishes to have a video chat, a video meet, or an online video date (hereinafter video date), from the requesting user to initiate the online video dating session. In one or more embodiments, the method or system may further uses the computing device to end the video date.

In one or more embodiments, the method or system may further uses the computing device to perform user authentication or user authorization for a user to allow the user to proceed with the online dating products or services. In one or more embodiments, the method or system may further uses the computing device to identify one or more user preferences, one or more criteria for various modules, one or more user characteristics, or any combination thereof either from the user, from the user's computing device, or from a non-transitory computer readable storage medium that is operatively connected with one or more servers. In one or more embodiments, the method or system may further uses the computing device that communicates with the one or more servers to identify statistical data from one or more other similar users.

In one or more embodiments, the method or system may further uses the computing device that communicates with the one or more servers to identify historical data from the user's prior activities. In some embodiments, the method or the system may identify such historical data from the user's own prior activities if the user has explicitly consented to such uses of his or her own historical data by, for example, expressly clicking on a checkbox to authorizes the one or more servers to collect and use such historical data. In one or more embodiments, the method or system may further optionally uses the computing device to identify a list of registered, participating users for the user based at least in part upon the one or more preferences, one or more criteria, one or more characteristics, the statistical data, the user's own historical data, or any combinations thereof.

In some embodiments, the method or system may be used to facilitate video conferences between parties who may be complete strangers with no prior contacts or relationships but have certain characteristics (e.g., certain expertise in certain fields) that match one or more criteria specified by at least one party. In these embodiments, a participating users and the requesting user need not have any prior contact with each other in person or via other means (e.g., emails, electronic-invites, online requests, etc.), need not belong to any organization (e.g., a corporation, a social networking group, a professional or amateur group, or a government or private entity, etc.), and need not have any prior connection of any kind either directly between the requesting user and the participating user or indirectly via a third party. For example, a requesting user who is interested in replacing a fuse box or in finding a professional with a particular background in micro-electromechanical systems may specify such an interest as a search criterion or a search preference in some embodiments. The method or system may then identify a list of registered, participating users who match the search criterion or preference and present the list to the requesting user. The requesting user may then use the video date function to have a video conference with one or more of the registered, participating users. As another example, a requesting user interested in finding a potential candidate for hire may also specify certain criteria or preference (e.g., education degree, major, requisite knowledge of specific tools, etc.), search for potential candidates from a pool of registered users to identify a list of potential candidates, and conduct an online video date with one or more of the potential candidates for, for example, interviewing purposes. In various embodiments, dating is not limited to a form of courtship including the act of meeting and engaging in social activities done by two people with the aim of each assessing the other's suitability as a partner in an intimate relationship or as a spouse and may generally comprise meeting of two people with the aim of each assessing the other's suitability for a candidate with common purposes or goals of any kind. In these embodiments, a date is also not limited to a person of the same or opposite sex with whom one makes or has made an appointment or engagement in social activities with the aim of each assessing the other's suitability as a partner in an intimate relationship or as a spouse and may generally encompass and include any user with whom a requesting user makes or has made an appointment or engagement in any activities with the aim of each assessing the other's suitability as a candidate for any common purposes or goals

In one or more embodiments, the method or system may further uses the computing device to identify a user's input to determine the format of the presentation of the list of registered users to the user. In one or more embodiments, the method or system may further uses the computing device to present the list of registered users to a requesting user based at least in part upon the one or more preferences, one or more criteria, one or more characteristics, or a combination thereof. In one or more embodiments, the method or system may further uses the computing device to provide real-time video chat or online date between two or more registered users. In some embodiments, the method or the system may provide real-time video chat or online date among the two or more registered users by using peer-to-peer communication without involving any servers.

In some embodiments, the method or the system may provide real-time video chat or online date among the two or more registered users by using client-server communication where all the data for the video chat or online date are routed through at least one server before such data are transmitted to the receiving user. In some of these embodiments, the method or the system does not necessarily require all the data for the real-time video chat or online date be routed through or processed by the one or more servers. In some embodiments, the method or system may process and route only a smaller portion of the total amount of data for the real-time video chat or online date among the two or more registered users, whereas the remaining data are transmitted by using peer-to-peer communication mechanisms. In these embodiments, the method or system uses a hybrid communication mechanism, which includes peer-to-peer communication mechanism and client-server communication mechanism, to facilitate video chat or video date among two or more registered users.

In one or more embodiments, the method or system may further uses the computing device that is communicatively coupled to one or more servers to provide other services that comprise, for example but not limited to, text messaging service, short message service (SMS), multimedia messaging service (MMS), etc. while providing the online video dating or video chat concurrently to facilitate multiple ways of communications between any two registered users of the two or more registered users. In one or more embodiments, the method or system may further uses the computing device to end the video chat session and to initiate data synchronization between a registered user and one or more servers. In one or more embodiments, the method or system may further synchronize data between a registered user's computing device and at least one of the one or more servers.

In one or more embodiments, the method or the system may use one or more servers to receive a request for video chat or online video date among two or more registered users. The two or more registered users include at least one requesting registered user who first expresses his or her intent to have a video chat or online video date with at least one registered, participating user by, for example, sending a video chat or video date request to the at least one registered, participating user. It shall be noted that the at least one registered, participating user need not necessarily have accepted the request for video chat or online video date in some of these embodiments. In one or more embodiments, the method or the system may use one or more servers to identify relevant data for the requesting user.

In one or more embodiments, the method or the system may use one or more servers to determine one or more security measures from at least one of the two or more registered users and react according to the one or more security measures. In one or more embodiments, the method or the system may use one or more servers to identify one or more recommendations or hints to any of the two or more registered users. In one or more embodiments, the method or the system may use one or more servers to identify whether all the registered users involved in this particular video chat or online video date have agreed to have the video chat or online video date. In some embodiments, the method or the system may further identify whether one or more of these two or more registered users have determined to decline, postpone, or reschedule the video chat or online video date with respect to any other registered users and respond accordingly.

In one or more embodiments, the method or the system may use one or more servers to activate or initialize one or more modules to process incoming data and outgoing data for each of the two or more registered users to facilitate the video date. In one or more embodiments, the method or the system may use one or more servers to receive incoming data for the video date from at least one registered user. For example, the method or the server may receive incoming audio data or visual data from at least one of the two or more registered users. In one or more embodiments, the method or the system may use one or more servers to process the received incoming data according to various requirements, options, criteria, etc. In one or more embodiments, the method or the system may use one or more servers to transmit and present the processed incoming data to one or more recipients (e.g., to a first registered user from whom the unprocessed incoming data are received and to one or more other registered users participating in the video date.)

In one or more embodiments, the method or the system may use one or more servers to optionally present both the incoming data, whether processed or unprocessed, and the outgoing data on a user interface. In one or more embodiments, the method or the system on a registered computing device may transmit the outgoing data to another user's computing device via a peer-to-peer communication mechanism. In some embodiments, the method or system may transmit the outgoing data from one registered user's computing device to a server and cause the server to process the received outgoing data based on the identified or received one or more security measures. In these embodiments, the method or the system may use one or more servers to transmit the processed outgoing data to a user's device.

In one or more embodiments, the method or the system may further invoke one or more module to enable a registered user to find a date. In one or more embodiments, the method or the system may further invoke one or more module to enable a registered users to learn which other registered users have viewed or reviewed any information about the registered user. In one or more embodiments, the method or the system may further invoke one or more module to provide a registered user with various requests (e.g., a request for profile, a request for video date, a request for relevant data, etc.) in various formats within a user-defined time period or a default time period or with the requests sent by the registered user to other registered users within a user-defined time period or a default time period.

In one or more embodiments, the method or the system may further invoke one or more module to enable a registered user to create, edit, or delete any information about the registered user. The information about the registered user may be in any format that may comprise, for example, a textual format, a binary format, a multimedia format, a proprietary format, an encrypted format, or a combination thereof and may be accessed by various hardware or software modules or applications (e.g., a database application) in some embodiments. Throughout this application, the information about the registered user will be termed as the profile of the registered user. In some embodiments, the profile may also include other data or information. It shall be noted that a profile is not necessarily limited to a single file. In other words, a profile may contain a single file in some embodiments and may include multiple files of different types in some other embodiments. In one or more embodiments, the method or the system may further invoke one or more module to enable a registered user to set up or change different settings about the video date application or various other related modules. More details about each of the aforementioned module or specific function will be provided below with reference to the drawing figures.

Some embodiments are directed at one or more computing devices such as one or more computing devices for implementing various actions or processes of the methods described above. Some embodiments are directed at an article of manufacture that stores thereupon a sequence of instructions which, when executed by at least one processor, a processor core, or a thread of a processor or a processor core (hereinafter processor), causes the at least one processor to execute various processes or actions of various methods described above.

### BRIEF DESCRIPTION OF THE FIGURES

The drawings illustrate the design and utility of various embodiments. It should be noted that the figures are not drawn to scale and that elements of similar structures or functions are represented by like reference numerals throughout the figures. In order to better appreciate how to obtain the above-recited and other advantages and objects of various embodiments, a more detailed description of the inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1A illustrates an exemplary schematic diagram of one or more computing devices that execute various modules or processes and interact with a user for implementing online video date in some embodiments.

FIG. 1B illustrates more details about the schematic diagram illustrated in FIG. 1A in some embodiments.

FIG. 1C illustrates more details about the schematic diagram illustrated in FIG. 1A in some embodiments.

FIGS. 1D-E illustrate some exemplary user interfaces for implementing online video date in some embodiments in some embodiments.

FIG. 2A illustrates a high level flow diagram for a method or system for implementing online video date in some embodiments.

FIG. 2B illustrates a high level flow diagram for a method or system for implementing online video date in some embodiments.

FIG. 2C illustrates a high level flow diagram for a method or system for implementing online video date in some embodiments.

FIG. 2D illustrates a high level flow diagram for a method or system for implementing online video date in some embodiments.

FIG. 3 illustrates a high level flow diagram for a method or system for implementing online video date in some embodiments.

FIG. 4 illustrates a high level flow diagram for a method or system for implementing online video date in some embodiments.

FIG. 5A illustrates more details for the high level flow diagram illustrated in FIG. 4 in some embodiments.

FIG. 5B illustrates an exemplary user interface for the flow diagram illustrated in FIG. 5A in some embodiments.

FIG. 5C illustrates an exemplary interaction to a user's input in the exemplary user interface illustrated in FIG. 5B in some embodiments.

FIG. 5D illustrates further details of the exemplary interaction to a user's input in the exemplary user interface illustrated in FIG. 5B in some embodiments.

FIG. 5E illustrates an exemplary response to a user's request for video date in the exemplary user interface illustrated in FIG. 5B in some embodiments.

FIG. 6A illustrates more details for the high level flow diagram illustrated in FIG. 4 in some embodiments.

FIG. 6B illustrates an exemplary user interface for the flow diagram illustrated in FIG. 6A in some embodiments.

FIG. 7A illustrates more details for the high level flow diagram illustrated in FIG. 4 in some embodiments.

FIG. 7B illustrates an exemplary user interface for the flow diagram illustrated in FIG. 7A in some embodiments.

FIG. 7C illustrates more details about the exemplary user interface for the flow diagram illustrated in FIG. 7A in some embodiments.

FIG. 7D illustrates an exemplary interaction to a user's input in the exemplary user interface illustrated in FIG. 7C in some embodiments.

FIG. 8A illustrates more details for the high level flow diagram illustrated in FIG. 4 in some embodiments.

FIG. 8B illustrates an exemplary user interface for the flow diagram illustrated in FIG. 8A in some embodiments.

FIG. 9 illustrates more details for the high level flow diagram illustrated in FIG. 4 in some embodiments.

FIG. 10 illustrates more details for the high level flow diagram illustrated in FIG. 4 in some embodiments.

FIG. 11 illustrates some schematic diagram of an exemplary system that may be used to implement some aspects of the invention.

### DETAILED DESCRIPTION OF ILLUSTRATED EMBODIMENTS

Various embodiments are directed to a method, system, and computer program product for implementing video date. Other objects, features, and advantages of the invention are described in the detailed description, figures, and claims.

Various embodiments of the methods, systems, and articles of manufacture will now be described in detail with reference to the drawings, which are provided as illustrative examples of the invention so as to enable those skilled in the art to practice the invention. Notably, the figures and the examples below are not meant to limit the scope of the present invention. Where certain elements of embodiments can be partially or fully implemented using known components (or methods or processes), portions of such known components (or methods or processes) that are necessary for an understanding of the present invention will be described, and the detailed descriptions of other portions of such known components (or methods or processes) will be omitted for ease of explanation and to not obscure embodiments of the invention. Further, embodiments encompass present and future known equivalents to the components referred to herein by way of illustration.

Various embodiments are directed at methods, systems, and articles of manufactures for implementing online video date. In various embodiments, the method or system enables a user, who has registered to use the online video dating products or services, to create or edit the information in a user's profile and enter the user's preferences or criteria for potential candidates for video dating in one or more embodiments. In some embodiments, the requesting, registered user need not be acquainted with or have any prior relationship with a potential candidate for video dating. In these embodiments, the requesting user need not even have any prior contact or relationship either in person or online with the potential candidates. In other words, a requesting user and a potential date (or “date” for simplicity) may be complete strangers.

In some embodiments, a requesting user and a date may have previously establish some forms of prior contact or prior relationship (e.g., either through sending or responding to various requests as described below or via agreeing to video date with each other). In some embodiments, the method or system may import these forms of prior contact or prior relationship from other social networks or from other dating services, either online or offline. In some embodiments, the method or system may then search its user database to identify a list of dates for a requesting user based at least in part upon the preference(s), criterion (criteria), information in the requesting user's profile, or a combination thereof. The method or system may then present the list of dates to the requesting user's computing device (e.g., on a user interface of a mobile computing device) while allowing the requesting user to adjust the presentation format of the list in some embodiments. The requesting user may then examine more details about some of the dates in the list and initiate a video date or other forms of communications with one or more dates from the list by interacting with various processes or modules via the user interface in some embodiments. More details about various processes or modules will be described below with reference to the drawing figures.

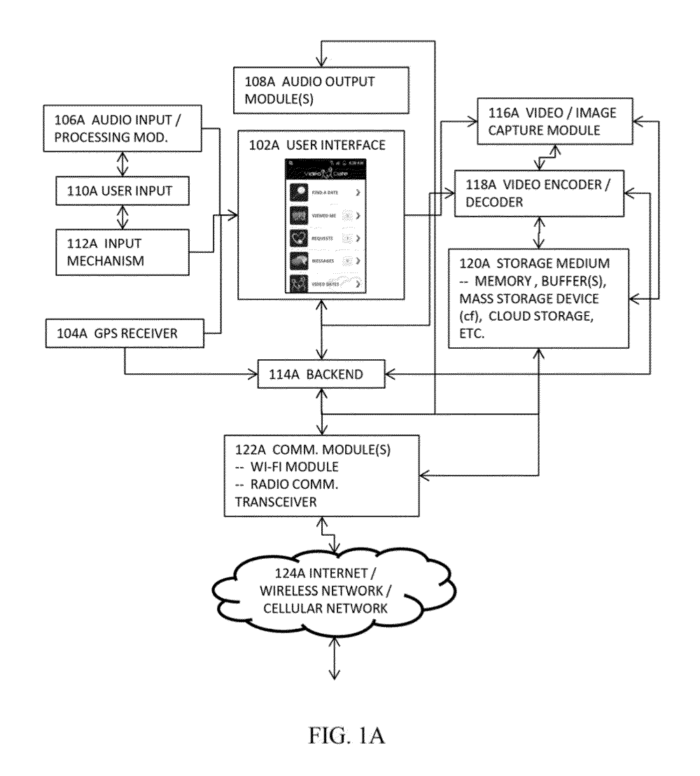

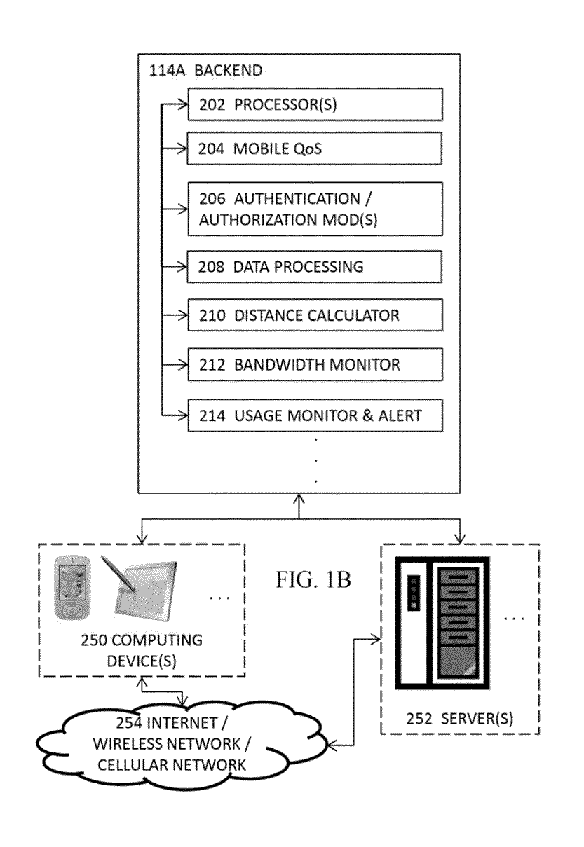

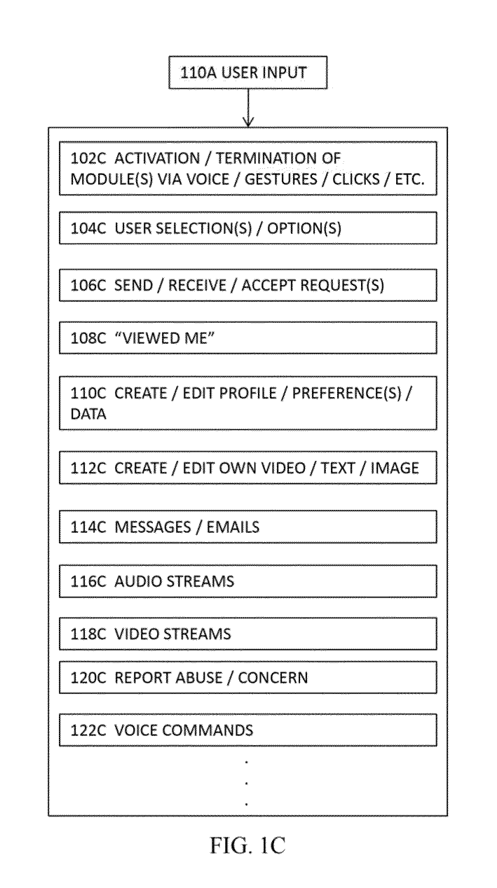

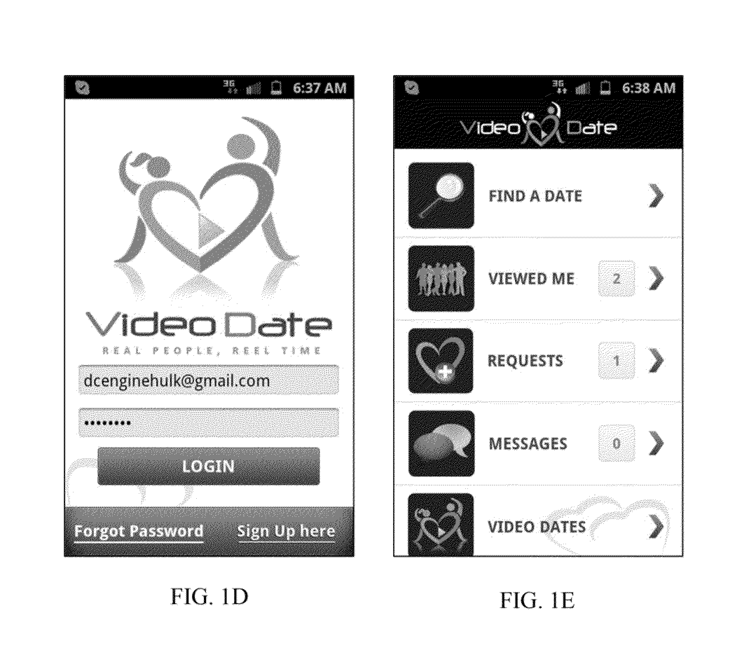

FIG. 1A illustrates an exemplary schematic diagram of one or more computing devices that execute various modules or processes and interact with a user for implementing online video date in some embodiments. In one or more embodiments, the method or system provides a user interface 102A that interacts with a user. The method or system may further be operatively coupled with an audio input or audio processing module 106A on a user computing device to receive and convert user's audio input 110A (e.g., a user's voice), which may be input into the user computing device via an input mechanism 112A (e.g., a microphone or a pre-recorded, electronic sound file), into electronic data stream (e.g., data packets) such that the user's audio input 110A may be transmitted across various forms of network (e.g., the Internet, wireless network(s), cellular network(s), or a combination thereof 124A) to other computing devices of other users in some embodiments.

In some embodiments, the method or system may further be operatively coupled to one or more audio output modules 108A (such as but not limited to a speaker module of a computing device, an earphone amplification module, various forms of codecs for different forms of audio data stream, or a combination thereof, etc.) to reproduce incoming audio data to a user. In some embodiments, the method or system may further be operatively coupled to a GPS (global positioning system) receiver or transceiver 104A of a computing device that may generate positioning data for the location of the computing device. The positioning data may be used to identify a user's location in some embodiments. In some embodiments, the method or system may further be operatively coupled to a video or image capture module 116A (e.g., 2-D or 3-D camera(s) or video camera(s) capable of taking both still pictures and videos) to capture images or videos.

In some embodiments, the method or system may further be operatively coupled to a video encoder 118A for encoding video data or a video decoder 118A to decode video data. A video encoder comprises a device, circuit, transducer, software program, algorithm, or a combination thereof that converts information captured by the video or image capture module 116A in one format or code to another format or code. An encoder is a device, circuit, transducer, software program, algorithm or person that converts information from one format or code to another, for the purposes of. standardization, speed, secrecy, security, or saving space by shrinking size. A decoder is a device, circuit, transducer, software program, algorithm or person that reverse the operations of an encoder. In some embodiments, the method or system may further be operatively coupled to a non-transitory computer storage medium 120A (e.g., volatile or non-volatile memory, buffer memory, mass storage device(s), cloud storage, etc.) to store various forms of data or information in various formats for various purposes.

In some embodiments, the method or system may further be operatively coupled to one or more communication modules 122A to connect a user computing device to one or more other computing devices or one or more servers. In some embodiments, the one or more communication modules may comprise a Wi-Fi module, which allows the computing device to exchange data wirelessly over a computing network by using, for example radio waves, a radio communication transceiver module, which is a radio network that allows a large number of portable transceivers (e.g., mobile communication devices) to communication with each other and with other fixed transceivers, or a combination thereof.

In some embodiments, the method or system may adopt the Session Initiation Protocol (SIP), which constitutes a signaling protocol or an Application Layer protocol for controlling the video date sessions over the radio network or Internet Protocol and for creating, modifying, and terminating unicast (e.g., video date involving two registered users) or multicast (e.g., video date involving more than two registered users) session with one or more media streams (e.g., audio stream, video stream, etc.) In some embodiments, the method or system may further be operatively coupled to a backend 114A to facilitate some functions described here. The backend 114A will be described with greater details in subsequent sections with reference to FIG. 1B.

FIG. 1B illustrates more details about the schematic diagram illustrated in FIG. 1A in some embodiments. More specifically, FIG. 1B illustrates more details about the backend 114A illustrated in FIG. 1A. In one or more embodiments, the backend 114A may comprise one or more processors 202, which may include at least one network processor, that are programmable devices serving at least one role as a data packet processor and performing various functions including, for example but not limited to, data bit-field manipulation, queue management, allocation and re-circulation of data packet buffers, computation, etc. in some embodiments. The backend 114A may provide quality of service (QoS) 204 that allows the transport of traffic with special requirements or allow computer networks to become as useful as telephone networks for audio conversations, as well as supporting new applications with even stricter service demands.

The quality of service 204 may include mobile QoS (or cellular QoS) that offers mobile QoS to customers just as the fixed line PSTN services providers and Internet Service Provider (ISP) may offer QoS for various services including non-elastic services such as streaming multimedia. The backend may also perform data processing 208 for data to facilitate various objectives described herein in some embodiments. The data processing may including, for example but not limited to, video data processing, up-scaling or downscaling of video resolution to fit the screen resolution requirements or bandwidth limitations of various computing devices, encoding/decoding or encrypting/decrypting data transferred between computing devices for security enhancement, processing video data in response to a user's security or identify protection requirements, etc.

The backend 114A may also include a distance calculator 210 that calculates the distance between a requesting user and a potential date in some embodiments. In some embodiments, the distance calculator 210 may use the ZIP code, residential or postal address, GPS data, or a combination thereof between two registered users to determine the distance between these two registered users in some embodiments. The backend 114A may also include a bandwidth monitor 212 to monitor the bandwidth that a computing device is capable of, the bandwidth that is currently in use by the computing device, or a combination of both in some embodiments. The backend 114A may use this bandwidth information to determine the optimal resolution or bit-rate of the data stream transmitted among various computing devices to improve the experience of video date or to provide uninterrupted video date experience. The backend 114A may also include a usage monitor 214 that monitors the usage of data by the video date product or service or by any other products on a computing device that transmits or receives data via the mobile network in some embodiments.

In some embodiments where the user may customarily define a limit on the amount of data transmitted or received over the mobile network, the backend 114A may further provide a warning or notification to the user via voice message, text message, or text in a pop-up window, or other suitable means to alert the user of the computing device that the data usage is coming close to the predetermined limit or has exceeded a certain percentage or portion of a predetermined limit on the amount of data. In some embodiments, various components or functional modules of the backend 114A may be in a computing device 250 of a user. In some embodiments, these various components or functional modules may be in one or more servers 254 that are connected to the computing device via, for example, the Internet, a wireless network, a cellular network, or any combination thereof.

FIG. 1C illustrates more details about the schematic diagram illustrated in FIG. 1A in some embodiments. More specifically, FIG. 1C illustrates more details about the user input 110A in some embodiments. In one or more embodiments, the user input 110A may include user's input (e.g., via one or more voice commands, direct input such as clicks, special gestures, etc. via an input device, or a combination thereof) for the activation or de-activation of various modules (102C). In one or more embodiments, the user input 110A may include one or more selections, options, or entries (104C) identified or provided by a user. The one or more selections, options, or entries may include textual, graphical, symbolic, or voice entry of a user's response to any part of the online dating services or products in some embodiments. In one or more embodiments, the user input 110A may include the user's response to or manipulation of any requests 106C related to a user.

For example, the requests 106C may include a request sent by the user, a request sent to the user, whether the user has accepted a certain request, how many requests the user has accepted, declined, put on hold, or rescheduled, how many requests the user has sent to a particular user, how many requests the user has received from a particular user, whether the user has blocked or reported any request from a particular user, etc. In some embodiments, the method or system may employ a data structure (e.g., a database, a table, etc.) that includes each participating registered user in, for example, a row. The method or system may also maintain, for each participating registered user, a list of other registered users that the each participating registered user has blocked or reported in some embodiments. During a search of a list of registered user for a requesting user, the method or system may examine the data structure and skip the user(s) that the requesting user has blocked or reported. In some embodiments, the method or system may, for a requesting user, maintain a link (e.g., a pointer, or a symbolic link between a user and one or more reported or blocked users in a database, etc.) that leads to a list of blocked or reported users that the requesting user has blocked or reported.

During a search, the method or system may examine the list pointed to by the link and skip the user(s) that the requesting user has blocked or reported. In these embodiments, the method or system may allow each user to block, ban, or report another registered user or to allow each user to remove another user from the banned or block data structure or list, without consulting another party's mechanisms or modules at all. The method or system may also, with the user's permissions, use such information in the data structure or list to provide hints or recommendations as described in this application. In some embodiments, the method or system may deactivate or freeze a user's account if the user has been blocked or reported by a predetermined number of users or a predetermined percentage of users who have been in contacted with the user. For example, a first user may have only contacted five other users via the provided products or services. Nonetheless, four of the five users reported or blocked the first user. The method or the system may then at least temporarily deactivate, freeze, or suspend the first user's account or give the first user a notification indicating that the first user's account will be deactivated, frozen, or suspended if the first user receives another number of reports or blocks from the time of the notification.

In one or more embodiments, the user input 110A may include user's response to or manipulation of various items in the “viewed me” module (108C), which will be described in greater details below. In one or more embodiments, the user input 110A may include the user's entries or manipulations in creating, editing, or deleting any video, text, image, messages, etc. (112C) in various modules described herein. In one or more embodiments, the user input 110A may include messages (e.g., SMS messages, MMS messages, etc.), emails, etc. created or manipulated by the user (114C) in various modules described herein. In one or more embodiments, the user input 110A may include user identified or created audio streams (e.g., user's voice in video or audio chat, user identified voice, sound, or music clips as background sound effects) in various modules (116C) described herein.

In one or more embodiments, the user input 110A may include user identified or created video streams (e.g., user's own video captured by the video or image capture module in a video date, the user identified background that replace the actual background of the environment in which the use is actually situated, etc.) in certain modules (116C) involving the video date functions described herein. In one or more embodiments, the user input 110A may include a user's reporting of another user being a concern or a user's reporting of abuse of various aspects of the online video dating products or services (120C). In one or more embodiments, the user input 110A may include one or more voice commands given by a user to manipulate various functions or modules of the online dating products or services described herein.

FIGS. 1D-E illustrate some exemplary user interfaces for implementing online video date in some embodiments in some embodiments. More specifically, FIG. 1D illustrates an exemplary login screen which receives a user's entry of the username and password for authenticating and authorizing the user to access various modules or functions described herein. FIG. 1D further provides a link to allow a unregistered user to sign up for the online video dating products or services described herein and another link to allow a user, who has forgotten the password, the username, or both, to reset or receive the forgotten password, username, or both. FIG. 1E illustrates a part of an exemplary user interface that shows the following expandable modules—“FIND A DATE”, “VIEWED ME”, “REQUESTS”, “MESSAGES”, “VIDEO DATES”. Each of the numbers associated with some of the expandable modules indicates how many items are categorized into the corresponding expandable module within a definable period of time (e.g., “since last login”, “within the past 24 hours”, etc.)

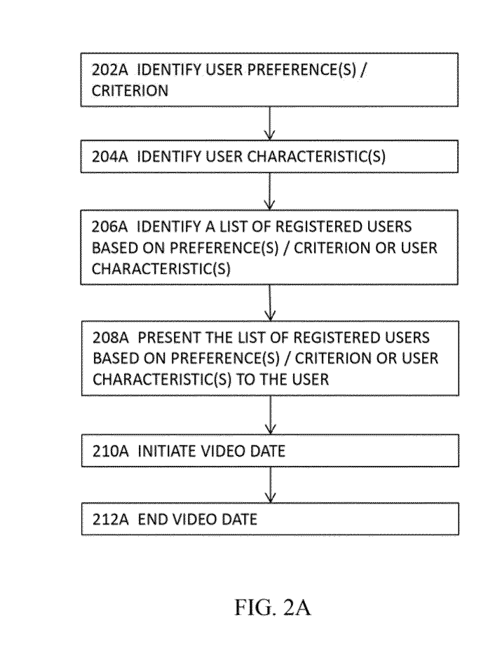

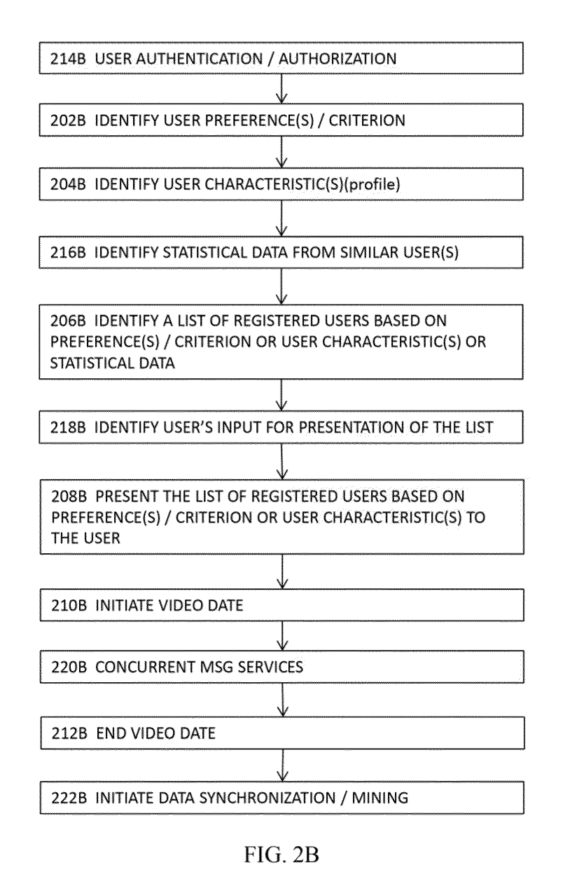

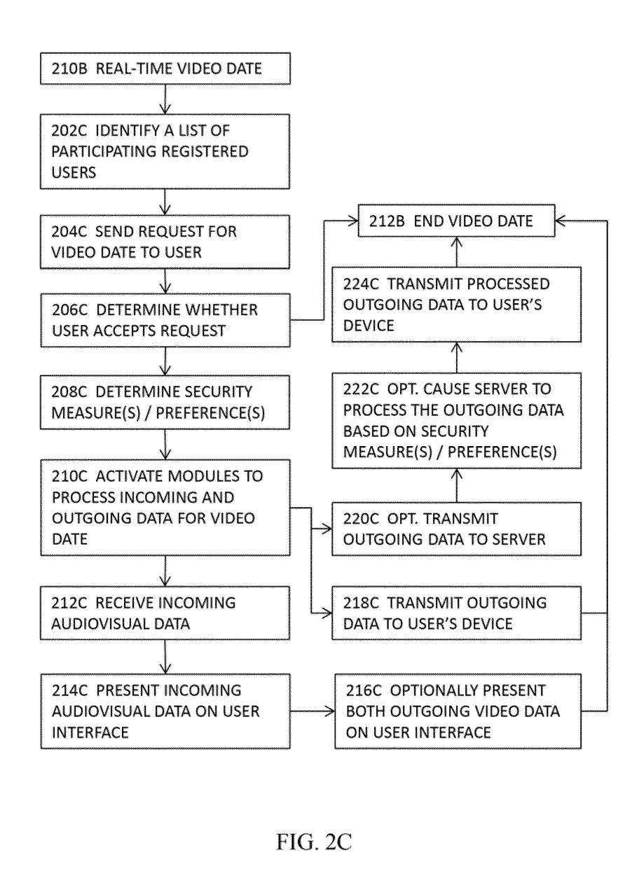

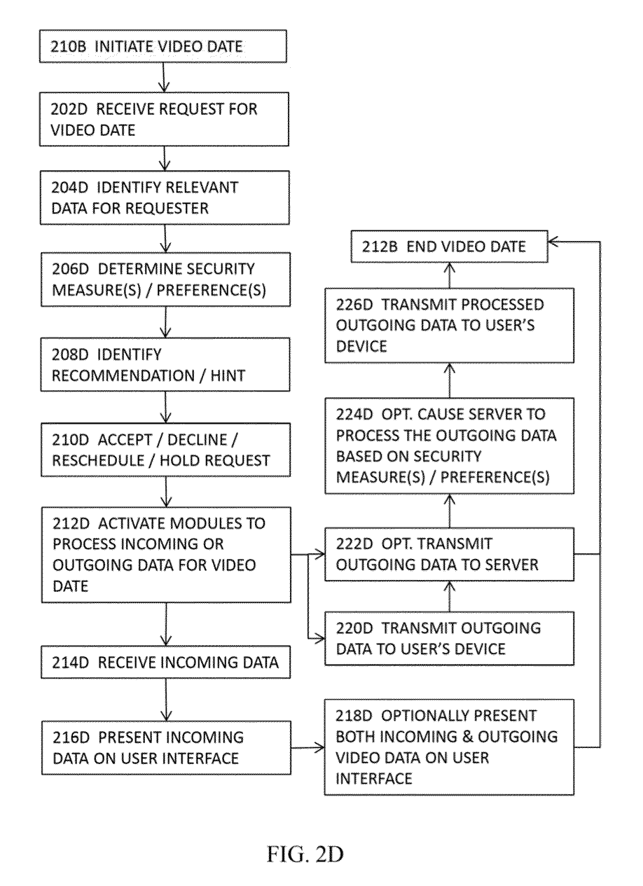

FIG. 2A illustrates a high level flow diagram for a method or system for implementing online video date in some embodiments. In one or more embodiments, the method or system may respectively comprise the process or hardware module for identifying one or more user preferences or criteria (202A) for another registered user to be considered as a potential candidate for video date. In some embodiments, the one or more user preferences or criteria may include, for example but not limited to, orientation (e.g., straight or lesbian), age or range of age of the potential candidate, ethnicity, body build type (e.g., athletic, etc.), height or range of height, weight or range of weight, marital status (e.g., single, married, divorced, widowed, etc.), “have kid(s)”, “would like to have kid(s)”, “expected length of relationship” (e.g., toward marriage, one day, three months, etc.), education, area of origin, hobbies, “smoker?”, “love pets?”, religion (specific religion, “don't care”, etc.), whether the potential date is associated with a picture, etc.

In some embodiments, the user may even assign different weights to different preferences or criteria to bias the identification process for the potential candidates. In some embodiments, the method or system may provide a custom field for the user to enter a special criterion or preference that will also be sent to other users so as to make the other users aware of such a special criterion or preference. In one or more embodiments, the method or system may respectively comprise the process or hardware module 204A for identifying one or more user's characteristics. In some embodiments, the one or more identified characteristics are stored in a profile as described in a preceding paragraph. In some embodiments, the one or more identified characteristics of the user may include, for example but not limited to, the user's own answers for or response to those preferences or criteria for the potential online video date candidates. In-some embodiments, the method or system may further ask for a user's permission to send no profile information, the complete profile, or a redacted version of the complete profile with the user's request, message, etc. and may send the corresponding version of the profile (none, redacted, or complete) of the user together with, for example, a request for video date such that the potential candidate may further view the sent profile information upon receipt of the request for video date.

In some embodiments, the method or system may further attach a text, picture, or video message to the request such that the recipient of the request may further view or review the attached message upon receipt of the request. In one or more embodiments, the method or system may respectively comprise the process or hardware module 206A for identifying a list of registered users based at least in part upon at least one of the one or more preferences or criteria for potential candidates identified at 202A, the one or more user's characteristics identified in 204A, and the special preference or criterion customarily created by the requesting user. In these embodiments, the requesting user need not be acquainted with a potential candidate in the list of registered users in some embodiments. In these embodiments, the requesting user and a potential candidate for video date may be complete strangers and have no prior contact or relationship by any means.

In some embodiments, the requesting user and a potential candidate may have become “friends” by either party or both parties' explicit acknowledge of the other as a “friend” as in some social network applications. In some embodiments, the requesting user and a potential candidate may have become “friends” by importing their “friend” relationship from other social network applications. In one or more embodiments, the method or system may respectively comprise the process or hardware module 208A for presenting the list of registered users to the requesting user. In some embodiments, the requesting user may predefine or define on the fly how the list of registered users is to be presented in his or her user interface. For example, the requesting user may determine that the list is to be presented by showing the newest registered users first, by showing the closest (geographically) registered users first, by showing the registered users with the best evaluation or statistics, which may be derived from other registered users, by the requesting user, or a combination, first, by showing the registered users who have been reported or blocked last, by showing the youngest first, etc.

In some embodiments, the method or the system may automatically or allow the user to sort the list of registered users by presenting the registered users with the highest matching confidence level first. For example, the method or system may perform some statistical processes (with or without the user-defined or default weights for different preferences, criteria, or characteristics, etc.) to perform one or more queries to filter out registered users who do not meet or match with any prohibitive preferences, criteria, or characteristics (e.g., all smokers will be filtered out by the query if the requesting user specifies “non-smoker” as a criterion), and then examine the profile information of the remaining registered users in the database to statistically determine the confidence level of matching the requesting user with a registered user. In one or more embodiments, the method or system may respectively comprise the process or hardware module 210A for initiating a video date with one or more registered users identified by the requesting user. In one or more embodiments, the method or system may respectively comprise the process or hardware module 212A for ending the video date.

FIG. 2B illustrates a high level flow diagram for a method or system for implementing online video date in some embodiments. In one or more embodiments, the method or system may respectively comprise the process or hardware module 214B for authenticating or authorizing the requesting user for the online video date products or services. In one or more embodiments, the method or system may respectively comprise the process or hardware module for identifying one or more user preferences or criteria (202B) for another registered user to be considered as a potential candidate for video date. In some embodiments, the one or more user preferences or criteria may include, for example but not limited to, orientation (e.g., straight or lesbian), age or range of age of the potential candidate, ethnicity, body build type (e.g., athletic, etc.), height or range of height, weight or range of weight, marital status (e.g., single, married, divorced, widowed, etc.), “have kid(s)”, “would like to have kid(s)”, “expected length of relationship” (e.g., toward marriage, one day, three months, etc.), education, area of origin, hobbies, “smoker?”, “love pets?”, religion (specific religion, “don't care”, etc.), whether the potential date is associated with a picture, etc.

In some embodiments, the user may even assign different weights to different preferences or criteria to bias the identification process for the potential candidates. In some embodiments, the method or system may provide a custom field for the user to enter a special criterion or preference that will also be sent to other users so as to make the other users aware of such a special criterion or preference. In one or more embodiments, the method or system may respectively comprise the process or hardware module 204B for identifying one or more user's characteristics. In some embodiments, the one or more identified characteristics are stored in a profile as described in a preceding paragraph. In some embodiments, the one or more identified characteristics of the user may include, for example but not limited to, the user's own answers for or response to those preferences or criteria for the potential online video date candidates.

In some embodiments, the method or system may further ask for a user's permission to send no profile information, the complete profile, or a redacted version of the complete profile with the user's request, message, etc. and may send the corresponding version of the profile (none, redacted, or complete) of the user together with, for example, a request for video date such that the potential candidate may further view the sent profile information upon receipt of the request for video date. In some embodiments, the method or system may further attach a text, picture, or video message to the request such that the recipient of the request may further view or review the attached message upon receipt of the request.

In one or more embodiments, the method or system may respectively comprise the process or hardware module 216B for identifying statistical data for the requesting user. In some embodiments, the method or system may identify the statistical data from the requesting user's own historical data. For example, the method or system may identify the data from the requesting user own historical data that show that the requesting user 76% of the time declined video date request from a registered user with “female”, “between age 29-32”, “having income between $100,000 and $130,000 per year”. In some embodiments, the method or system may identify the statistical data from users that are similar to the requesting user in some aspects. In some embodiments, the method or system may determine that a registered user is “similar” to the requesting user if the method or system identifies one or more common characteristics, one or more preferences, one or more criteria, or any combinations thereof between the registered user and the requesting user.

In some embodiments, the method or the system may also determine two registered users to be “similar” if the method or system determines that the patterns of actions (e.g., accepting similar requests, declining other similar requests, etc.) these two registered users are similar to a certain extent (e.g., over 75% of the patterns of actions match). In one or more embodiments, the method or system may respectively comprise the process or hardware module 206B for identifying a list of registered users based at least in part upon at least one of the one or more preferences or criteria for potential candidates identified at 202B, the one or more user's characteristics identified in 204B, and the special preference or criterion customarily created by the requesting user in a substantially similar manner as that described in 206B. In one or more embodiments, the method or system may respectively comprise the process or hardware module 218B for identifying a user's input for how the list of registered users is to be presented to the requesting user. In one or more embodiments, the method or system may respectively comprise the process or hardware module 208B for presenting the list of registered users to the requesting user in a substantially similar manner as that described for 208A. In one or more embodiments, the method or system may respectively comprise the process or hardware module 210B for initiating a video date among the requesting user and one or more registered users in the list.

In one or more embodiments, the method or system may further respectively comprise the process or hardware module 220B for providing other services that comprise, for example but not limited to, text messaging service, short message service (SMS), multimedia messaging service (MMS), etc. while providing the online video dating or video chat concurrently to facilitate multiple ways of communications between any two registered users of the two or more registered users. In these embodiments, the users may view or review additional information enclosed in these services while having a video date. In one or more embodiments, the method or system may further respectively comprise the process or hardware module 212B for ending a video date. In one or more embodiments, the method or system may further respectively comprise the process or hardware module 222B for initiating data synchronization between a user's computing device and a server.

In some embodiments, any modifications to existing data that have been stored on the server will be captured by the synchronization. In some embodiments, all data will be synchronized between the user's computing device and the server, and duplication will be identified and removed to conserve space. In one or more embodiments, the method or system may further respectively comprise the process or hardware module 220B for performing data mining, knowledge discovery in data, or various analyses on the data (hereinafter data mining) that are related to the requesting user's use of the online video date products and services. In some embodiments, the various analyses comprise one or more mathematical or statistical analyses such as but not limited to various regression analyses or analyses using pattern matching techniques. Various techniques for data mining such as statistics, artificial intelligence, or expert systems may be utilized in various embodiments, and thus a particular data mining technique shall not be considered as limiting the scope of various embodiments or the scope of the claims. In some embodiments, the method or system performs data mining for the data related to a user's use of the online video date products and services only upon the express consent of the user or agreement to the policy or terms or conditions. In some embodiments, the data will be analyzed to further aid the user in identifying potential dates or to aid the method or system to more precisely provide recommendations or hints to the user or other similar users.

FIG. 2C illustrates a high level flow diagram for a method or system for implementing online video date in some embodiments. More specifically, FIG. 2C illustrates more details about the process or hardware module 210B for initiating video date of FIG. 2B. In one or more embodiments, the method or system for implementing online video dating respectively comprises the process or hardware module 202C for identifying a list of registered users and presenting the list to a requesting user. The registered users and the requesting user may be complete strangers without any prior relationships or prior contact in some embodiments. The registered users and the requesting user may also have some prior contact (e.g., having previous video date(s), having sent some forms of profile(s), etc.) in some other embodiments. A registered user and the requesting user may also have some prior relationship if they have some forms of prior contact, or such a prior relationship may be imported from other online or offline dating products or services. The requesting user may select one or more registered users from the list of registered users presented.

In one or more embodiments, the method or system for implementing online video dating respectively comprises the process or hardware module 204C for sending a request to the one or more registered users identified from the list. In some embodiments, the one or more requests may comprise a request for profile, a request for textual chat, or a request for video chat. In one or more embodiments, the method or system for implementing online video dating respectively comprises the process or hardware module 206C for determining whether the one or more registered users accept the request. A registered user may be presented with the options of accepting or declining the request, placing the request on hold (e.g., when the registered user sends another request for additional information or data to further view or review the requesting party). A registered user may also send a response to the request to reschedule the proposed meet (e.g., video date, textual chat, etc.), and the method or system may send a different request including the new schedule proposed by the registered user back to the requesting user.

In one or more embodiments, the method or system for implementing online video dating respectively comprises the process or hardware module 208C for determining one or more measures or one or more preferences for security from the requesting user or from at least one of the registered users receiving the request. The one or more measures or preferences for security may comprise whether the background of the video stream is to be removed or replaced with either a default background or a background of choice from a user such that the other users in the video date cannot discern the whereabouts of the user. In one or more embodiments, the method or system for implementing online video dating respectively comprises the process or hardware module 210C for activating one or more modules to process incoming data or outgoing data of a registered user who has determined to impose some security measures or preferences.

For a registered user, there is the outgoing data the comprise the multi-media data (e.g., audio data, video data, audiovisual data, etc.) captured by the computing device of the registered user. For example, the outgoing data may comprise the audiovisual data of a registered user captured by the webcam of his own computing device for the purpose of sending such audiovisual data to another registered user for a video date. There is also incoming data for the same registered user that comprise the multi-media data sent by other registered users to the registered user. In these embodiments where one user determines the background is to be replaced or removed, the method or system may process the video data captured by the video capture module to recognize the face and body of the registered user and remove the portion of video data other than the face and body of the registered user or replace the portion of video data other than the face and body of the registered user with one of multiple user selectable backgrounds or a background of choice (e.g., a photo, a picture, etc.) determined by the registered user. The face recognition of a photo, a picture, etc. may further be used to guard against Internet spams where certain users use Internet robots or “spiders” with fake identity for the purpose of other than what is intended with the online dating products or services.

After processing the video data, the method or system may further synchronize the video data and the audio data before transmitting the synchronized data to another registered user participating in the video date. In some embodiments, the method or system may, with the permission from a user, to perform face recognition to obtain a user's face image or one or more characteristics of a user's face. The method or system may further compare the face image obtained via face detection to the profile image(s) with some scaling between the two or more images for identify verification in some embodiments. In some embodiments, the method or the system may compare the one or more characteristics of a user's face with the corresponding one or more characteristics extracted from the user's profile picture for identity verification. In some embodiments, the method or the system may associate a match in the identity verification with a higher score and a mismatch, which may indicate a fake profile or some other identity issues, with a lower score. In some embodiments, the method or system may associate a relative score based at least in part on the degree of match between the image or one or more characteristics thereof and the corresponding profile image or the corresponding one or more characteristics thereof.

For example, a higher percentage of match may be associated with a higher score. In some embodiments, the method or system may use the identity match information described herein and ask a registered user to provide further identification. In some embodiments, the method or system may provide the identity verification information of a registered user to other registered users such that other registered users may have higher confidence in dealing with the registered user. In some embodiments, the user may hold the ultimate authority in deciding whether or not the method or system may obtain an image or one or more characteristics from live video stream via, for example face recognition, for the purposes of identity verification, or whether the method or system may distribute the identity verification information to other users. In these embodiments, the method or system may perform the identity verification without referencing any third party's identity verification modules, mechanisms, or data (e.g., a user's profile or related data.) This is to avoid the problems with the ease of creating fake identifications or profiles in some public domain tools such as facebook™, myspace™, law enforcement agency (agencies), or any publicly available or private sources, etc.

In some other embodiments, the method or system may also leverage a third party's identity verification module, mechanism, or data to perform identity verification. In some embodiments, the method or system may use a hybrid identity verification scheme, part of which relies solely on the internal verification scheme as described, and the remaining part of which leverages third party's identity verification module, mechanism, or data. For example, the method or system may perform face recognition to determine a match level between recognized image (or characteristic(s) thereof) and the profile image(s) (or corresponding characteristic(s) thereof) and use such information, with the permission from the user, to determine whether a registered user is the one he or she claims himself or herself to be in some embodiments.

In one or more embodiments, the method or system for implementing online video dating respectively comprises the process or hardware module 212C for receiving incoming data from one or more registered users in the list. The method or system may further present the incoming data on the user interface of the requesting user at 214C in some embodiments. In one or more embodiments, the method or system for implementing online video dating respectively and optionally comprises the process or hardware module 216C for presenting both outgoing data and the incoming data on the user interface of a registered user in, for example, a picture-in-picture style or windowed-style presentation. The method or system may end video chat at 212B if one participating registered user terminates the video date, or there has been no substantial changes in one of the incoming data streams (indicating the corresponding registered party may have lost connection or may have left the video date).

In some embodiments after 210C, the method or system for implementing online video dating respectively comprises the process or hardware module 218 C for transmitting the outgoing data to the computing devices of the one or more registered users identified from the list. The transmitted outgoing data will be presented to the one or more registered users in a similar manner as what is described for the requesting user above. In some embodiments after 210C, the method or system for implementing online video dating respectively comprises the process or hardware module 220C for optionally transmitting the outgoing data to one or more servers. In these embodiments, the method or system leverages the processing powers of the one or more servers to process the received outgoing data to implement the identified one or more measures or preferences for security. In some embodiments, the entire multi-media data will be transmitted to the one or more servers for processing. The one or more servers will also synchronize the audio and video data before finally transmitting the synchronized data to a receiving registered user.

In some embodiments, only the video portion will be transmitted to the one or more servers for processing while the audio portion will be transmitted directly to the buffer of the computing device of a receiving registered user while the video portion is processed by the one or more servers. The audio portion will be subsequently synchronized with the processed video portion before the synchronized portion is displayed on the user interface. In one or more embodiments, the method or system for implementing online video dating respectively comprises the process or hardware module 222C for causing the one or more servers to process at least a portion of the outgoing data of a registered user based at least in part upon the one or more measures or one or more preferences for security. In one or more embodiments, the method or system for implementing online video dating respectively comprises the process or hardware module 224C for transmitting the processed outgoing data to the computing device of a registered user for the video date. In one or more embodiments, the method or system for implementing online video dating respectively comprises the process or hardware module 212B for ending the video date.

FIG. 2D illustrates a high level flow diagram for a method or system for implementing online video date in some embodiments. More specifically, FIG. 2D illustrates more details about the process or hardware module 210B for initiating video date of FIG. 2B. In one or more embodiments, the method or system for implementing online video dating respectively comprises the process or hardware module 202D for receiving a request for video date from a requesting user. In some embodiments, the method or system may further respectively comprise the process or module 204D for identifying relevant data for the requesting user. In some embodiments, the method or system may identify relevant data from the data arising from the requesting user's own use of the products or services. In some other embodiments, the method or system may identify the relevant data from the data of other similar users' use of the online video dating products or services. In some embodiments, the relevant data may comprise whether the requesting user has been reported by other registered users as a concern, whether the requesting user has been reported to have abuse any aspects of the products or services, rule of reasons, or any commonly acceptable code of conduct or basic decency, or whether the requesting user has been blocked by any other registered users.

In some embodiments, the method or system may further respectively comprise the process or module 206D for determining one or more measures or preferences for security. In some embodiments, the method or system may further respectively comprise the process or module 210D for identifying whether one or more registered users receiving the request from the requesting user have accepted, declined, or held the request for video date. In some embodiments, the method or system may further respectively comprise the process or module 210D for rescheduling the requested video date to some later time or to another date and time. In some embodiments, the method or system may further respectively comprise the process or module 212D for activating or initializing one or more modules to process incoming data or outgoing data for at least one registered user agreeing to have the video date or for the requesting user. In these embodiments, the requesting user is communicating with the one or more registered users for the purpose of having a video date by using a client-server communication mechanism or a hybrid communication mechanism including the peer-to-peer communication mechanism and the client-server communication mechanism to transmit the data (e.g., audio data, video data, or audiovisual data, etc.) to and from each of the participating, registered users.

For example, a first registered user, who has determined to implement some security measures or preferences to have the background of the video removed or replaced, may use a client-server communication mechanism to send all outgoing data (e.g., audio data and video data) via one or more servers or may use a hybrid communication mechanism to send the audio data via the peer-to-peer communication mechanism and the video data via the client-server communication mechanism that will coordinate with all the computing devices of the participating users to synchronize the audio and visual data among all the computing devices. As another example, a second registered user, who has determined not to implement any security measures or preferences, may simply use the peer-to-peer communication mechanism and send and receive all the data through, for example, the cellular network or the wireless network to other participating registered users for the purpose of having the video date. In some embodiments, the method or system may further respectively comprise the process or module 214D for receiving incoming data from a registered, participating user. In these embodiments, the incoming data are transmitted via the peer-to-peer communication mechanism from one computing device to another.

The process or module 214D for receiving incoming data may be a part of the computing device of the registered, participating user in some embodiments. In some embodiments, the method or system may further respectively comprise the process or module 216D for presenting the incoming data on the user's interface of the computing device of the registered, participating user. In some embodiments after 212D, the method or system may further respectively comprise the process or module 220D for transmitting the processed outgoing data from a registered, participating user to another registered, participating user's computing device. In these embodiments, the method or the system uses one or more servers to processing the outgoing data from the registered, participating user. In some embodiments, the method or system may further respectively comprise the process or module 220D for optionally transmitting the outgoing data (e.g., audiovisual data captured by a registered user's computing device) to one or more computing devices. In these embodiments, the method or system may transfer the entire data or a portion thereof (e.g., audio data only) for the video date via a peer-to-peer communication mechanism.

In some embodiments, the method or system may further respectively comprise the process or module 222D for transmitting the processed outgoing data to one or more servers. In these embodiments, the method or system uses one or more servers in a client-server communication mechanism to transfer data to computing devices of various registered, participating users or a hybrid communication mechanism as described above. In some embodiments, the method or system may further respectively comprise the process or hardware module 224D for optionally causing the one or more servers to process the outgoing data received at 222D. In some embodiments, the method or system may further respectively comprise the process or hardware module 224D for optionally causing the one or more servers to process the outgoing data from a participating user. In some embodiments, the one or more servers may process the outgoing data based at least in part upon the one or more measures or one or more preferences for security before transmitting the outgoing data to another computing device for the video date.

For example, the one or more servers may process the outgoing data captured by a registered user's computing device to perform face recognition or to remove or replace the background of the video stream while preserving the images of the participating user to accommodate the security measures or preferences set by the participating user. The one or more servers in these embodiments may coordinate with the computing devices of the participating users to synchronize the audio portion and the processed video portion of the data before the processed data are finally displayed on a user interface to ensure that the audio and video portion of the data are synchronized while accommodating the security measures or preferences. In some embodiments, the one or more servers process the data. In some other embodiments, the computing device, which is determined to have sufficient processing power, processes the data. In some other embodiments, the processing of data is distributed among the one or more servers and the computing device(s). In some embodiments, the method or system may further respectively comprise the process or hardware module 226D for transmitting the processed outgoing data to a computing device of a participating user. In some embodiments, the processed data are first placed in some buffers, on the server side, the computing device side, or both, and then synchronized before the synchronized, processed data are finally forwarded to the user interface for display.

In some embodiments, the method or system may further respectively comprise the process or hardware module 212B for ending the video data session for one or more participating users. For example, if more than a pre-determined threshold number of participating users determine to kick a particular user from the current video data session, the method or system may optionally send a notification to the particular user and then terminate the incoming and outgoing communication channels on the computing device of the particular user. As another example, a participating user may determine to terminate the current video date session, and the one or more server or his or her own computing device will react accordingly.

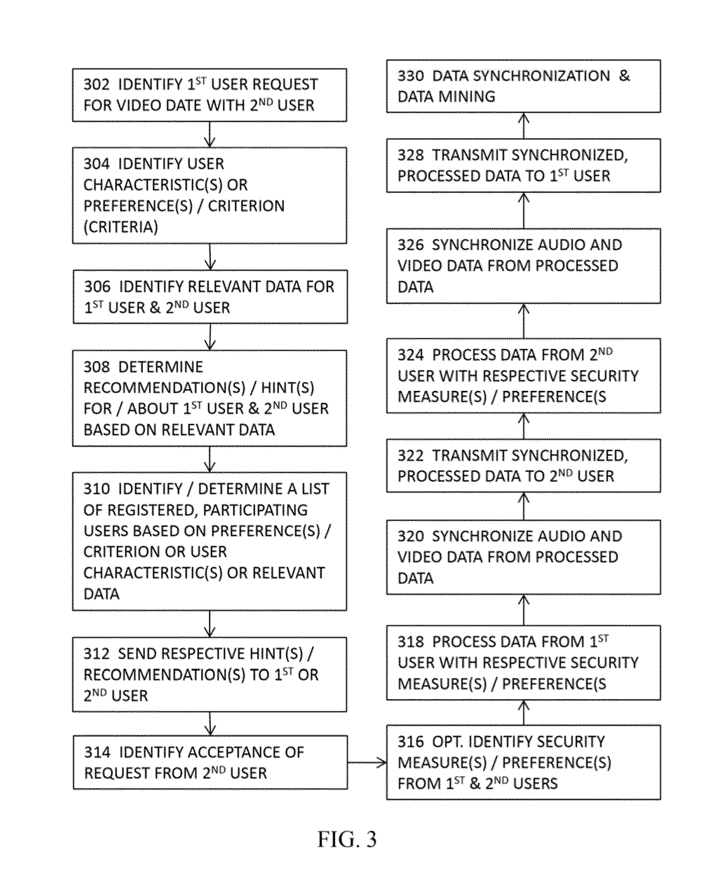

FIG. 3 illustrates a high level flow diagram for a method or system for implementing online video date in some embodiments. In some embodiments, the method or system may further respectively comprise the process or hardware module 302 for identifying a first user request for a video date with a second user. In some embodiments, the method or system may further respectively comprise the process or hardware module 304 for identifying one or more user characteristics, one or more user preferences, or one or more criteria, or any combinations thereof from the first user who requests for the video date. In some embodiments, the method or system may further respectively comprise the process or hardware module 306 for identifying relevant data about the first user. In some of these embodiments, the method or system may transmit the identified relevant data for the first user to the second user automatically, upon the request of the second user, or with the permission of the first user.

In some embodiments, the method or system may further respectively comprise the process or hardware module 306 for identifying relevant data for the second user. In some of these embodiments, the method or system may transmit the identified relevant data for the first user to the second user automatically, upon the request of the second user, or with the permission of the first user. In some embodiments, the method or system may identify relevant data from the data arising from the requesting user's own use of the products or services. In some other embodiments, the method or system may identify the relevant data from the data of other similar users' use of the online video dating products or services. In some embodiments, the relevant data may comprise whether the requesting user has been reported by other registered users as a concern, whether the requesting user has been reported to have abuse any aspects of the products or services, rule of reasons, or any commonly acceptable code of conduct or basic decency, or whether the requesting user has been blocked by any other registered users.

In some embodiments, the method or system may further respectively comprise the process or hardware module 308 for determining one or more recommendations or hints for the first user or for the second user. In some embodiments where the relevant data of one user are sent to the other use, the method or system may further respectively comprise the process or hardware module 308 for determining one or more recommendations or one or more hints about the first user or about the second user. For example, upon the identification of the second user by the first user to have a video date, the method or system may identify the relevant data about the second user which indicate that the second user has been blocked a number of times by other users in prior video dates, or has been blocked a number of times by other users similar to the first user, or has been blocked by the first user, etc., the method or the system may send a recommendation or hint to the first user according to the relevant data and ask the first user whether the first user would still like to proceed.

The method or the system may also collect the relevant data about the first user and send a recommendation or hint to the second user. The second user may use such a recommendation or hint to determine whether the second user is to accept the request. In some embodiments, the method or system may further respectively comprise the process or hardware module 310 for identifying or determining a list of other registered users and present the list to the first user or the second user or both to determine whether additional users are to be invited to the video date. In some embodiments, the method or system may further respectively comprise the process or hardware module 312 for sending one or more recommendations or hints to the respective participating users. In some embodiments, the method or system may further respectively comprise the process or hardware module 314 for identifying acceptance to the request from the second user.

In some embodiments, the method or system may further respectively comprise the process or hardware module 316 for optionally identifying one or more measures or one or more preferences for security from the first user or the second user, or from both the first user and the second user. Each participating user may set his or her own measures or preferences for security in some embodiments. In some embodiments, the method or system may further respectively comprise the process or hardware module 318 for processing the data (e.g., the video data of outgoing data from a participating user) from the first user. In some embodiments, the method or system may further respectively comprise the process or hardware module 320 for synchronizing the audio portion and the processed video portion of data for the purpose of having the video date. In some embodiments, the method or system may further respectively comprise the process or hardware module 322 for transmitting the synchronized, processed data to the second users.

In some embodiments, the method or system may further respectively comprise the process or hardware module 324 for processing the data (e.g., the video data of outgoing data from a participating user) from the second user. In some embodiments, the method or system may further respectively comprise the process or hardware module 326 for synchronizing the audio portion and the processed video portion of data for the purpose of having the video date. In some embodiments, the method or system may further respectively comprise the process or hardware module 328 for transmitting the synchronized, processed data to the first users. In one or more embodiments, the method or system may further respectively comprise the process or hardware module 330 for performing data mining, knowledge discovery in data, or various analyses on the data (hereinafter data mining) that are related to the requesting user's use of the online video date products and services.

In some embodiments, the various analyses comprise one or more mathematical or statistical analyses such as but not limited to various regression analyses or analyses using pattern matching techniques. Various techniques for data mining such as statistics, artificial intelligence, or expert systems may be utilized in various embodiments, and thus a particular data mining technique shall not be considered as limiting the scope of various embodiments or the scope of the claims. In some embodiments, the method or system performs data mining for the data related to a user's use of the online video date products and services only upon the express consent of the user or agreement to the policy or terms or conditions. In some embodiments, the data will be analyzed to further aid the user in identifying potential dates or to aid the method or system to more precisely provide recommendations or hints to the user or other similar users.

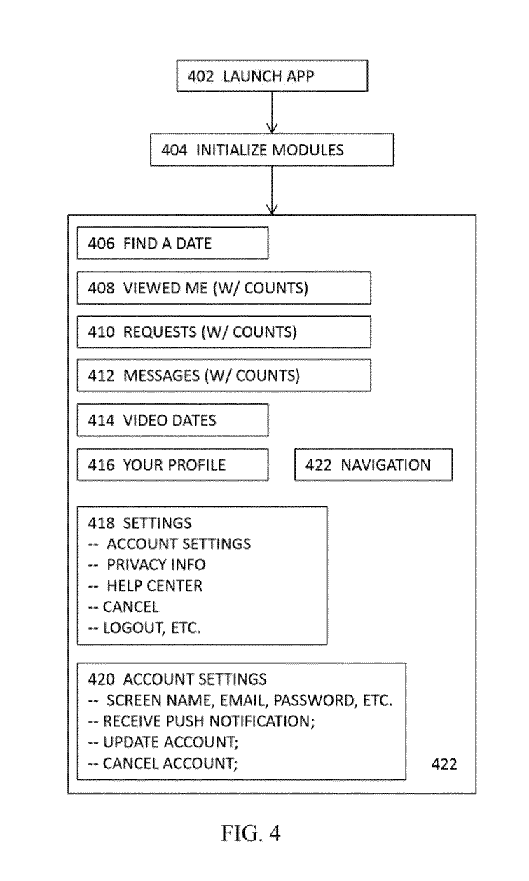

FIG. 4 illustrates a high level flow diagram for a method or system for implementing online video date in some embodiments. More specifically, FIG. 4 illustrates a modular view of the online dating product or service in some embodiments. At 402, the method or system for implementing online video date may respectively comprise the process or hardware module for receiving a user's command to launch the online dating product or service in some embodiments. For example, the method or the system may receive a user's input to launch the online video dating product or service on the user's computing device. At 404, the method or system for implementing online video date may respectively comprise the process or hardware module for initializing one or more modules on the computing device or on one or more remotely located servers in some embodiments. Once initialized, the method or system may provide various functionalities 422 which will be described below at the top level. More details about these various functionalities will be described with further details in subsequent paragraphs with reference to specific drawing figures. The method or the system, once initialized, may provide the process or module 406 to enable the user to find one or more potential candidates for dating purposes in some embodiments.

The method or the system may provide the process or module 408 to enable the user to know which registered users have accessed or viewed any information about the user in some embodiments. The method or the system, once initialized, may provide the process or module 410 to enable the user to create, modify, or review one or more requests sent by the user or their respective related data or review one or more requests sent to the user by one or more other registered users in some embodiments. The method or the system, once initialized, may provide the process or module 412 to enable the user to use messaging services to send text message or multimedia messages to one or more other registered users in some embodiments. The method or the system, once initialized, may provide the process or module 414 to enable the user to request for and initiate video date with one or more registered users in some embodiments.

The method or the system, once initialized, may provide the process or module 416 to enable the user to create or modify the user's profile or to determine which one or more levels of access to varying degrees of details of the user profile in some embodiments. The method or the system may further enable the user to determine which level of access is to accompany which actions in some embodiments. For example, a user may determine a first level of access to the minimum, basic information (e.g., age, ethnicity, weight, height, etc.) for other registered users to review when such other registered users attempt to access the user's profile. As another example, a user may determine a second level of access to the full profile information that will be transmitted together with a request for video date sent by the user such that the recipient may review as much information as there is to aid his or her decision of whether or not to accept the request.

The method or the system, once initialized, may provide the process or module 418 to enable the user to adjust various settings of the online video dating products or services or any other aspects of the products or services in some embodiments. In some embodiments, the various settings include account settings 420 in which a user may create or edit, for example but not limited to, screen name, email, motto shown with the profile picture, email address, and different levels of access to certain piece of information about the user. For example, a user may categorize any piece of information into a certain level of access and determine which level of access is to be associated with certain actions. In some embodiments, the account settings further include the process or module to enable a user to update the user's account or to cancel the user's account.

In some embodiments, the method or system may determine whether a user agrees to receive push notification. If the user agrees to receive push notification, the method or system may cause a daemon process to reside in the volatile memory of the user's computing device such that the user may still receive updates even when the user has terminated the online dating products or services on his or her computing device. For example, the daemon process enables the user to know whether there has been a request for video date, whether there has been a request for the user's profile, whether other registered users have sent any messages to the user, etc. even when the user has already exited and terminated the online dating products or services. In some embodiments, the daemon process comprises a computer program running as a background process but is not under the direct control of the user, although the user may ultimately terminate the daemon process.

In some embodiments, the daemon process is not necessarily a single process but may comprise one or more parent processes, one or more child processes, or both. In some embodiments where an Android platform is involved, a daemon process may comprise a Service or a Service object, which is an application component representing the application's desire to perform a longer-running operation while not interacting with the user or to supply functionality for other applications to use. In these embodiments, the daemon process may run in the main thread of its hosting process or may spawn its own thread to perform its intended functions, and the daemon process may inform the computing system or the operation system thereupon about the intended functions the daemon process will perform in the background and may proceed for an application to expose some of the application's (e.g., messaging application, etc.) functionality to other applications. In some embodiments where certain operation system does not permit any daemon process to run in the background, the method or system may block the thread at, for example, applicationWillTerminate such that the program resident in the background will not be terminated in a short time as the user terminates the online dating products or services. Such a resident program may be terminated either by the user or automatically upon the expiration of a user-definable time period with the option to continue for the next user-definable time period.

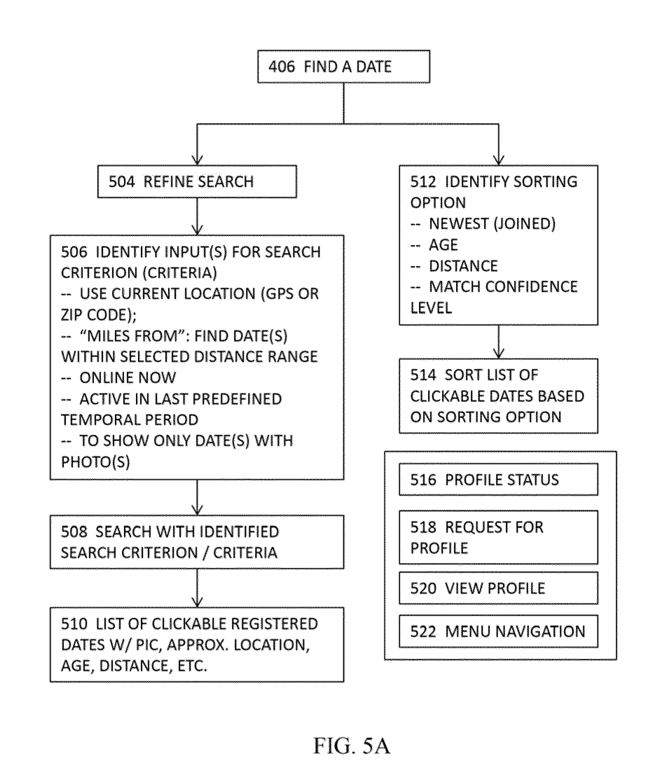

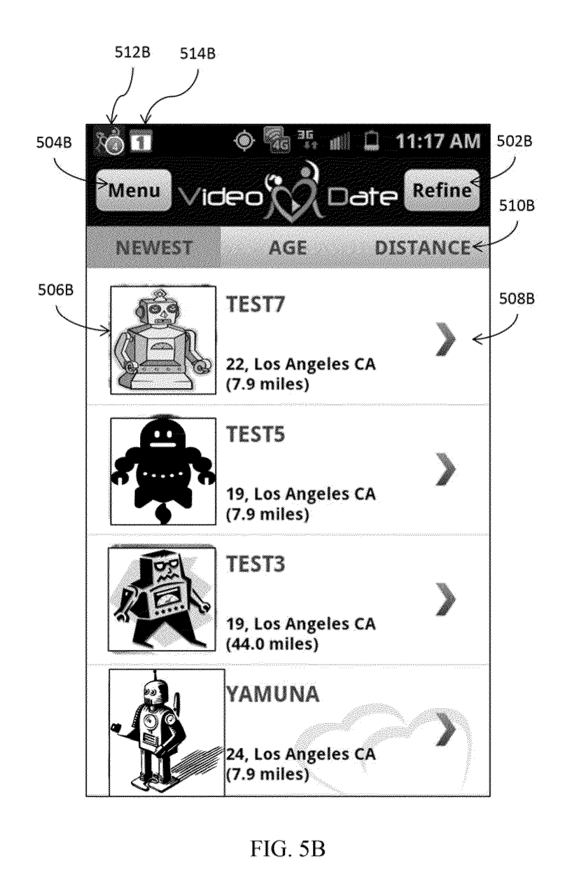

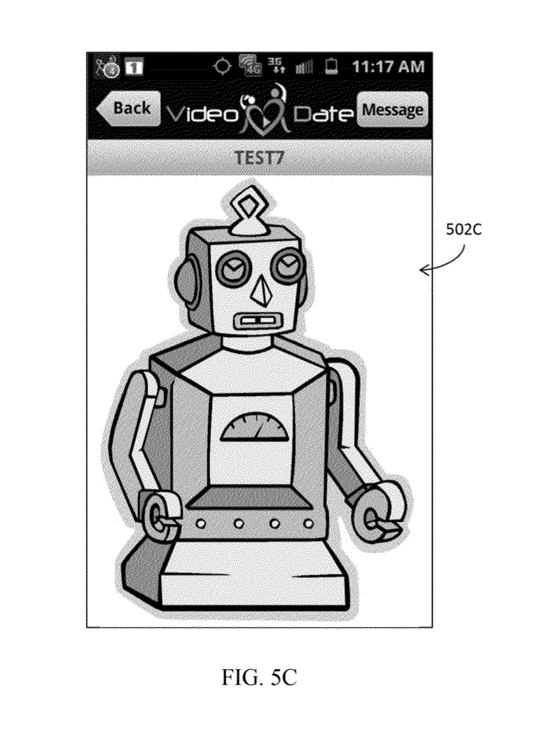

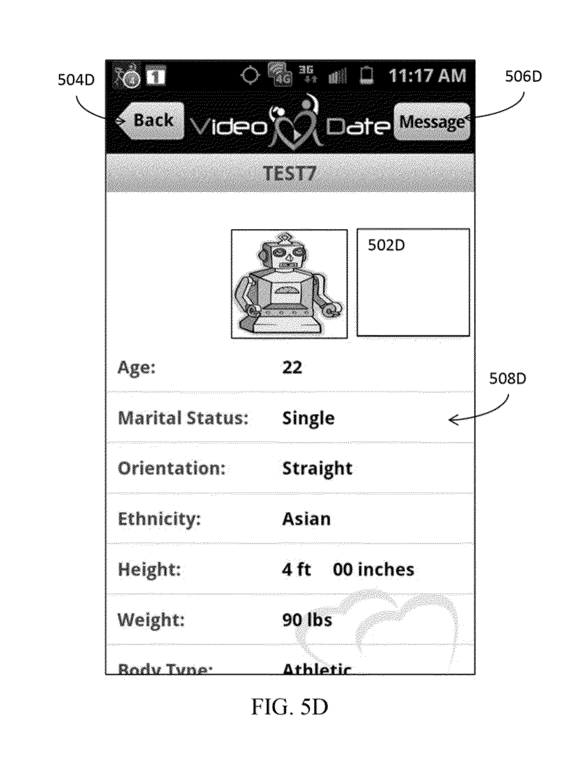

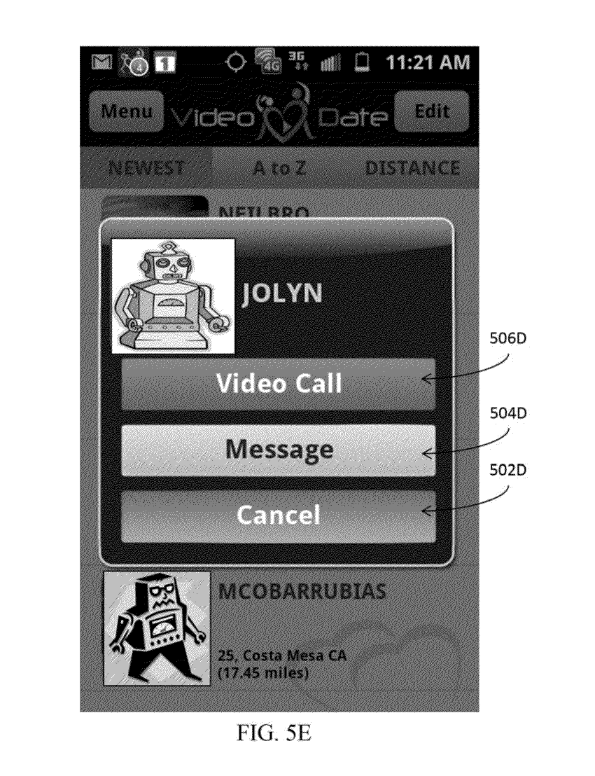

FIG. 5A illustrates more details for the high level flow diagram illustrated in FIG. 4 in some embodiments. More specifically, FIG. 5A illustrates more details about the “find a date” process or module 406 in FIG. 4. In one or more embodiments, the method or system may respectively comprise the process or hardware module 504 for refining the search for potential candidates among registered users to populate the list of registered users for a requesting user. In one or more embodiments, the method or system may respectively comprise the process or hardware module 506 for identifying one or more inputs for one or more search criteria. For example, the user may determine whether the distance calculator process or module is to use the ZIP code, the GPS positioning data, or a combination (e.g., ZIP code for the requesting user, and GPS data for a potential candidate) in determining the list of users within a user-definable search radius from the requesting user (e.g., 5 miles, 10 miles, 25 miles, 5,000 miles, etc.)

The one or more search criteria may also comprise a limit on users who are currently online only in some embodiments. The one or more search criteria may comprise a limitation on users who are active in the previous user-definable time period. The one or more search criteria may comprise a filter process or a database query process to filter out users who do not have profile pictures. In some embodiments, the one or more search criteria may include a user-definable matching confidence level. For example, the user may specify that only registered users who are determined to have 75% or better matching confidence level may be considered as potential candidates. In one or more embodiments, the method or system may respectively comprise the process or hardware module 508 for searching for registered users with the one or more identified search criteria.

In some embodiments where a filtering process or a query process is included in the one or more search criteria, the method or system may perform such a filtering process or the query process first to reduce the number of possible candidates for additional process in order to reduce the time and resources required for the search. In one or more embodiments, the method or system may respectively comprise the process or hardware module 510 for identifying or determining a list of registered users, each of which may be expandable by, for example, clicking on each registered user in the list. In some embodiments, the list may also be associated with the profile pictures, the approximate location, or basic personal data (e.g., age, weight, etc.) of a registered user or an approximate distance of a registered user from the requesting user. In one or more embodiments, the method or system may respectively comprise the process or hardware module 512 for identifying a sorting option form the requesting user that initiated the “find a date” process.

In some embodiments, the sorting option may be used to present the registered users by the time each registered user in the list joined the online dating products or services. In some embodiments, the sorting option may include age, distance, or matching confidence level, etc. In one or more embodiments, the method or system may respectively comprise the process or hardware module 514 for sorting the list of registered users based at least in part upon the identified sorting option. In one or more embodiments, the method or system may respectively comprise the process or hardware module 516 for determining whether any registered user in the list has granted access to the registered user's profile or the level of access to the profile of such registered user in the list. In one or more embodiments, the method or system may respectively comprise the process or hardware module 518 for sending a request for profile to one or more registered users in the list. In one or more embodiments, the method or system may respectively comprise the process or hardware module 520 for viewing the profile of a registered user in the list. In one or more embodiments, the method or system may respectively comprise the process or hardware module 522 for enabling the requesting the user to navigate through various menu options.

FIG. 5B illustrates an exemplary user interface for the flow diagram illustrated in FIG. 5A in some embodiments. More specifically, the exemplary user interface includes a menu button 504B that, when clicked upon, brings the requesting user back to the main menu or to the previous menu screen. The exemplary user interface may also include the “refine” button which, when clicked upon, enables the requesting user to refine the one or more search criteria. The list of registered users identified is presented with profile pictures (506B for the first registered user in the list) and a symbol 508B indicating that the particular user there may exist additional information to review. The exemplary interface may also include the sorting options 510B (e.g., NEWEST, AGE, DISTANCE as shown) and push notifications 512B and 514B, where 512B indicates the number (“4” shown in FIG. 5B) of video date requests sent to the requesting user during a definable time period, and 514B indicates the number of messages sent to the requesting user during a definable time period. The exemplary user interface in FIG. 5B shows four registered users with cartoonish images as the profile images for privacy reasons. It is permitted to use such an image for the profile image for a registered user although a registered user may also use his or her own actual photograph as the profile image.

FIG. 5C illustrates an exemplary interaction to a user's input in the exemplary user interface illustrated in FIG. 5B in some embodiments. More specifically, FIG. 5C illustrates the profile picture 502C when the requesting user clicks on either the profile picture 506B or the symbol 508B in FIG. 5B. FIG. 5D illustrates further details of the exemplary interaction to a user's input in the exemplary user interface illustrated in FIG. 5B in some embodiments. The exemplary interface includes the “Back” button 504D which, when clicked upon, brings the requesting user back to the previous screen, the “Message” button 506D which, when clicked upon, brings up a message creator for creating a text message or a multimedia message, one or more additional pictures 502D of the registered user, or additional information 508D to which the registered user has granted access. In some embodiments, the method or the system may further respectively comprise the process or module for allowing the user to initiate a vide date from one or more of the aforementioned screens. FIG. 5E illustrates an exemplary response from the system to a user's request for video date in the exemplary user interface illustrated in FIGS. 5B-D in some embodiments. The user interface includes a “Video Call” button 506D, a “Message” button 504D, and a “Cancel” button 502D.

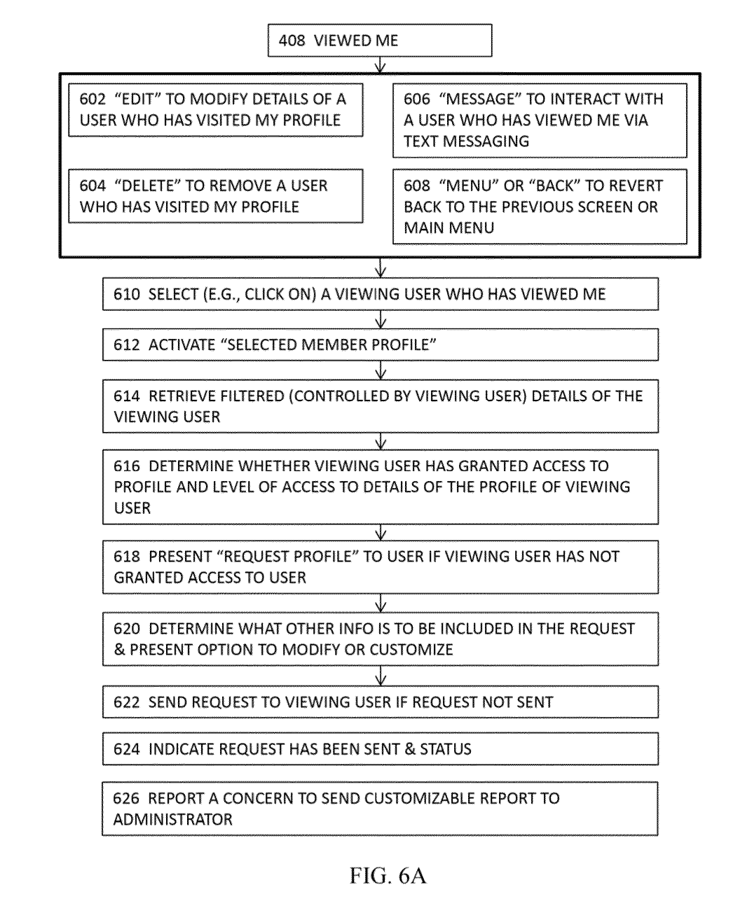

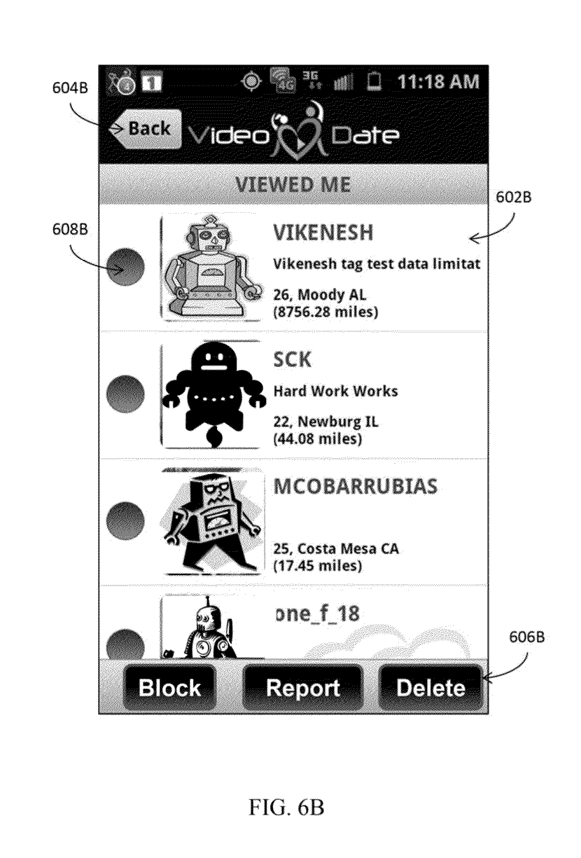

FIG. 6A illustrates more details for the high level flow diagram illustrated in FIG. 4 in some embodiments. In one or more embodiments, the process or module 408 may respectively include the “edit” process or module 602 for modifying details of a user who has visited or viewed a requesting user's profile. In one or more embodiments, the process or module 408 may respectively include the “delete” process or module 604 for removing a registered user who has visited or viewed my profile. In one or more embodiments, the process or module 408 may respectively include the “message” process or module 606 for interacting with another registered user, who has viewed the requesting user's profile, via messaging services. In one or more embodiments, the process or module 408 may respectively include the “menu” or “back” process or module 602 for reverting back to a previous screen or main menu. In one or more embodiments, the process or module 408 may respectively include the process or module 610 for selecting a viewing registered user who has viewed or visited the requesting user's profile.

In some embodiments, the process or module 408 may respectively include the process or module 612 for activating the “selected member profile” to determine whether the profile of a viewing registered user may be accessed. In some embodiments, the process or module 408 may respectively include the process or module 614 for retrieving filtered detail level of the profile of the viewing registered user. In some embodiments, the process or module 408 may respectively include the process or module 616 for determining whether the viewing, registered user has granted access to the profile and the level of the access that is granted. In some embodiments, the process or module 408 may respectively include the process or module 618 for allowing the requesting user to send a request for profile to the viewing, registered user, if the viewing, registered user has not granted any level of access to any part of his or her profile. In some embodiments, the process or module 408 may respectively include the process or module 620 for determining what other information is to be sent together with the request for profile.

For example, the requesting user may determine to grant a first level of access to the requesting user's profile and accompany the request for profile with the first level of access. In some embodiments, the process or module 408 may respectively include the process or module 622 for sending the request to the viewing, registered user if the request has never been sent. In some embodiments, the process or module 408 may respectively include the process or module 624 for indicating that a similar request for profile has been sent to the same viewing user. In some embodiments, the method or system may further indicate the status of the previously sent request(s) to inform the requesting user whether the request has been responded to, or whether the previous request has been declined or placed on hold. In some embodiments, the process or module 408 may respectively include the process or module 626 for reporting a concern about the viewing user to the administrator if the requesting user considers any part of the displayed information about the viewing user may be inappropriate or suspicious. In some embodiments, the reported concerns about particular users may be accessible by other registered users either automatically or upon request. In some other embodiments, the reported concerns about particular users may not be accessible by the general, registered users.

FIG. 6B illustrates an exemplary user interface for the flow diagram illustrated in FIG. 6A in some embodiments. The exemplary interface includes a “back” button to bring the user back to the previous screen. The exemplary interface also shows a list of registered users that may be selected by checking the radio button 608B for the first registered user 602B. The exemplary interface also provides three buttons 606B to block or report selected registered users in the list or to delete selected, registered users from the list.

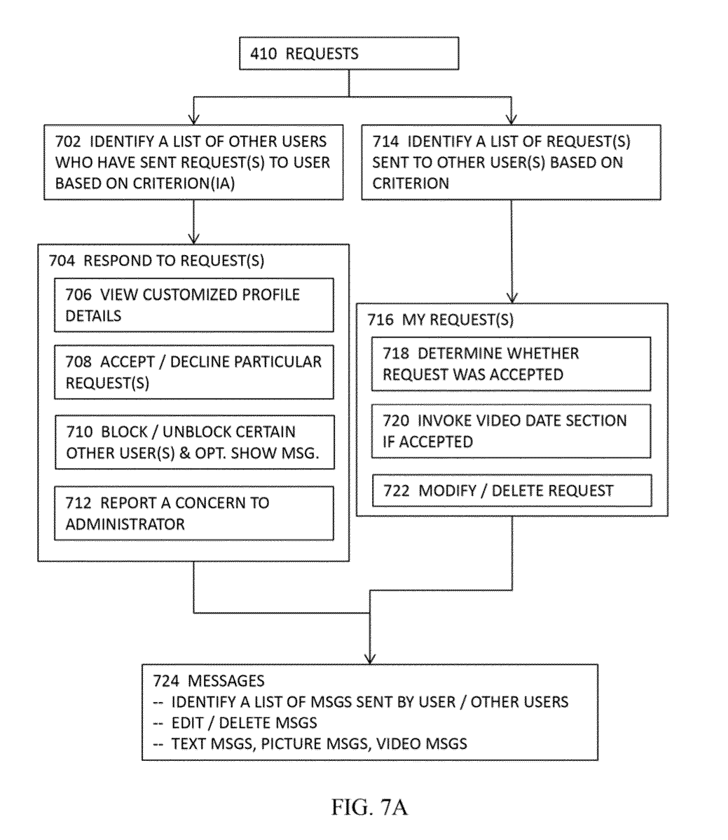

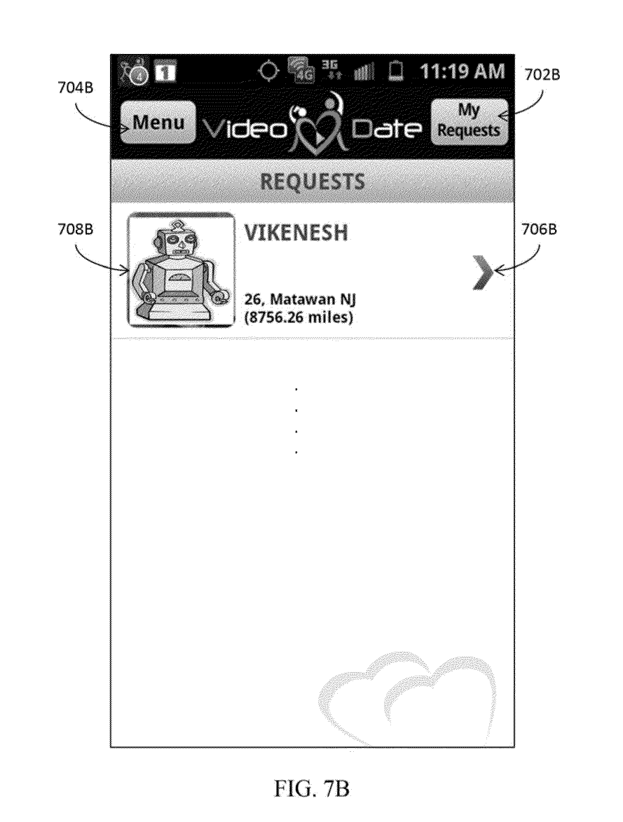

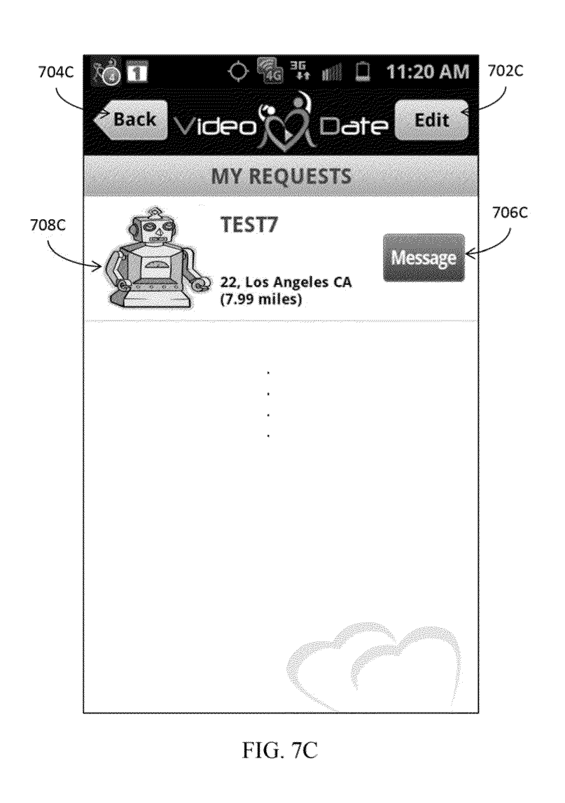

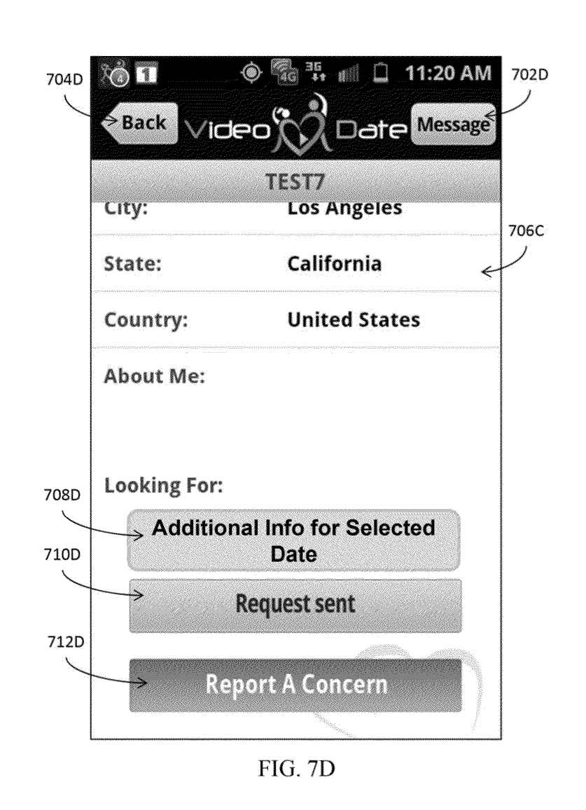

FIG. 7A illustrates more details for the high level flow diagram illustrated in FIG. 4 in some embodiments. In some embodiments, the “request” process or module 410 may respectively comprise the process or module 702 for identifying a list of other registered users who have sent requests to the requesting user based on one or more criteria. In some embodiments, the one or more criteria include whether any of these other registered users have accompanied their requests with their profiles. In some embodiments, the one or more criteria may include the statistical data about a registered user that indicate, for example, how many times the registered user's profile has been viewed by others, etc. In some embodiments, the “request” process or module 410 may respectively comprise the process or module 704 for responding to a request. In some embodiments, the process or module 704 may include the process or module 706 for viewing customized profiled details that are granted by a registered user, the process or module 708 for accepting or declining a particular request, the process or module 710 for blocking or unblocking a registered user with an optional message or notification to indicate whether the registered user has been blocked, the process or module 712 for reporting a concern to an administrator about a particular registered user.

In some embodiments, the “request” process or module 410 may respectively comprise the process or module 724 for providing messaging services that may enable a use to identify a list of messages sent by either the user or by other registered users or to edit or delete a particular message. The messages may comprise text messages or multimedia messages (e.g., picture messages or video messages) in some embodiments. In some embodiments, the “request” process or module 410 may respectively comprise the process or module 714 for identifying a list of requests 716 that are sent from the requesting user to one or more other registered users based at least in part on one or more criteria. In some embodiments, the “request” process or module 410 may respectively comprise the process or module 718 for determining whether any request in the list has been accepted by another registered user.

In some embodiments, the “request” process or module 410 may respectively comprise the process or module 720 for invoking the video date module if any requests have been accepted. In some embodiments, the “request” process or module 410 may respectively comprise the process or module 722 for modifying or deleting a request from the list of requests. For example, the requesting user may identify a previously sent request, modify the content of the request or the level of access to the requesting user's profile, or whether or not additional information or data about the requesting user is to accompany the request. The method or the system may then ask the requesting user whether the requesting user would like to resend the request to the designated registered user.

FIG. 7B illustrates an exemplary user interface for the flow diagram illustrated in FIG. 7A in some embodiments. The exemplary user interface illustrated in FIG. 7B includes a “Menu” button 704B which, when clicked upon, reverts back to the immediately previous screen that the requesting user visited or to the main menu. The exemplary user interface illustrated in FIG. 7B includes a list of requests that are sent by other registered user(s) to the requesting user. Each request in the list includes a profile picture and brief data about the registered user 708B. The method or system may use the symbol 706 in each request to indicate that additional information is available for this request. The requesting user may, for example, click on the symbol to access such additional information. A request in the list may include a request for profile, a request for video date, a request for textual chat, etc. The exemplary user interface illustrated in FIG. 7B includes a “My Request” button 702B which, when clicked upon, proceeds to display a list of requests that the requesting user has sent to other registered user(s).

FIG. 7C illustrates more details about the exemplary user interface for.the flow diagram showing the “my request” section illustrated in FIG. 7A in some embodiments. The exemplary user interface illustrated in FIG. 7C includes a “Menu” button 704C which, when clicked upon, reverts back to the immediately previous screen that the requesting user visited or to the main menu. The exemplary user interface illustrated in FIG. 7B includes a “Edit” button 702C which, when clicked upon, brings up a particular request for editing or modification. The exemplary user interface displays a list of requests that the requesting user sent to other registered user(s). Each request in the list may include a profile picture and some data 708C (e.g., age—22 in this example, approximate location—Los Angeles Calif. in this example, and approximate distance—7.99 miles in this example) about the user that sent this particular request. The exemplary user interface also includes a “Message” button 706C which, when clicked upon, brings up the messaging module for the requesting user to send text or multimedia messages to the registered user sending this particular request.

FIG. 7D illustrates an exemplary interaction to a user's input in the exemplary user interface illustrated in FIG. 7C in some embodiments. This exemplary user interface shows the additional data or information about the a particular request sent by the requesting user or by another registered user to the requesting user when, for example, the requesting user clicks on the, request 708C, or when the another registered user clicks on the symbol 706B or 708B. This exemplary user interface includes a “Message” button 702D which, when clicked upon, brings up the messaging module for the requesting user to send text or multimedia messages to the registered user to whom this particular request was previously sent. This exemplary user interface also shows additional functions 708D to enable the requesting user to request, for example from a server, additional information about the particular registered user (or selected date as shown in FIG. 7D).

The additional information may include whether the particular registered user is associated with any reports of abuse of concern, whether this particular registered user has been blocked by other registered users, the matching confidence level, etc. This exemplary user interface also shows that this request has been sent to the designated user 710D to inform the requesting user of the status of the request. The status may also include “Request on Hold” to indicate that the receiving user has placed this request on hold, “Request Rescheduled” which, when clicked upon, shows the detailed information about the new schedule for this request, or “Request Declined” to show that this request has been declined by the receiving user. This exemplary user interface also shows additional functions 712D to enable the requesting user to report a concern about the receiving user of this particular user.

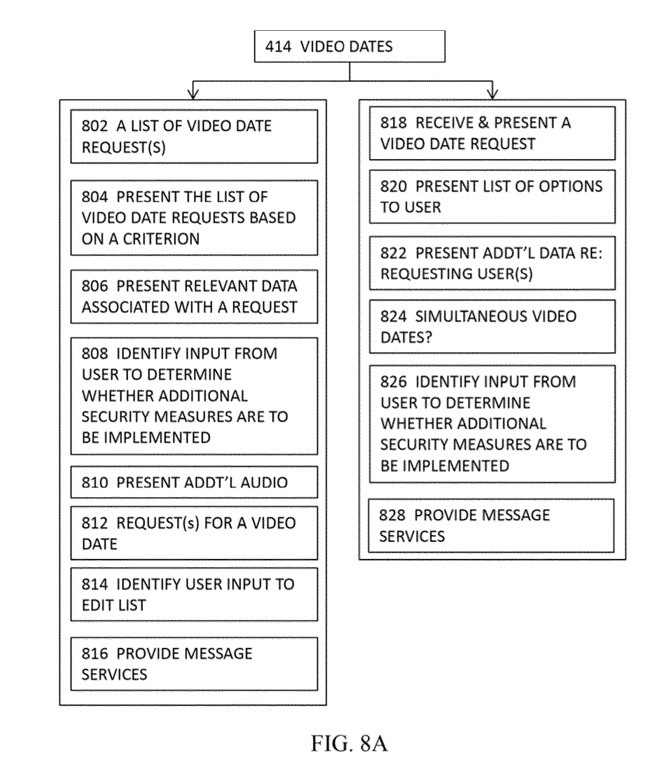

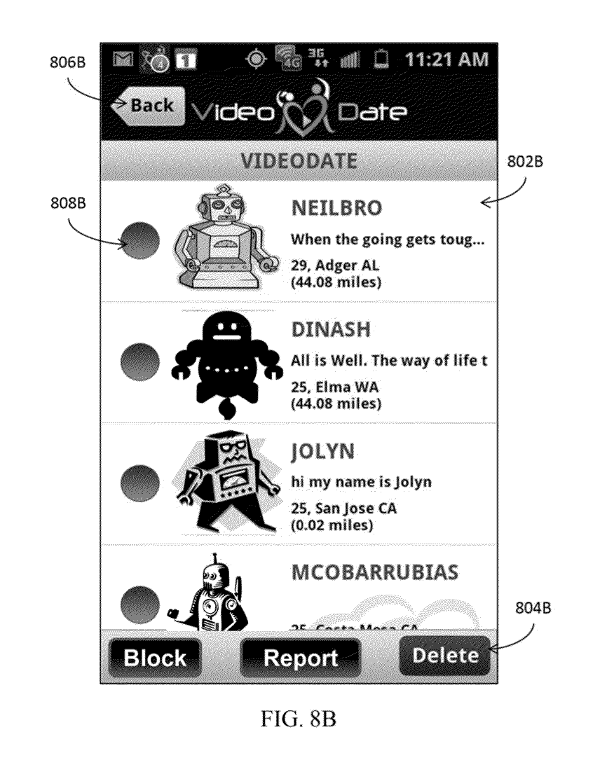

FIG. 8A illustrates more details for the high level flow diagram illustrated in FIG. 4 in some embodiments. In one or more embodiments, the process or module 414 may respectively comprise the process or hardware module 802 for identifying a list of requests (e.g., request(s) for video date, request(s) for profile, request(s) for messaging, request(s) for textual chat, etc.) In one or more embodiments, the process or module 414 may respectively comprise the process or hardware module 804 for presenting the list of requests based at least in part upon one or more criteria or one or more preferences. The one or more criteria or one or more preferences may include one or more sorting criteria or preferences, or matching confidence levels of the receiving users in the list of requests, or any other criteria or preferences described herein with respect to other processes or modules.

In one or more embodiments, the process or module 414 may respectively comprise the process or hardware module 806 for presenting relevant data associated with a request. The relevant data may include whether the receiving user has been reported as a concern, whether the receiving user has been blocked by other user(s), whether the receiving user has granted access to the profile of the receiving user, etc. In one or more embodiments, the process or module 414 may respectively comprise the process or hardware module 808 for identifying an input from the requesting user to determine whether one or more measures or preferences for security are to be implemented. For example, the requesting user may determine to have the background replaced or removed in the video stream in a request for video date. In one or more embodiments, the process or module 414 may respectively comprise the process or hardware module 810 for presenting additional audio during a video date.

For example, the requesting user may wish to have a particular background music during a video date. The method or system may ask the requesting user to identify the background music (e.g., an MP3 music file) and transmit or play such background music together with the audio and video data during the video date. In one or more embodiments, the process or module 414 may respectively comprise the process or hardware module 812 for sending or resending a request to one or more other registered users. In one or more embodiments, the process or module 414 may respectively comprise the process or hardware module 814 for identifying a user input to edit the list of requests or a particular request thereof. For example, the requesting user may further require to show whether a particular request is associated with an accessible profile about the sending user, or the requesting user may refine or filter which requests should be displayed. In one or more embodiments, the process or module 414 may respectively comprise the process or hardware module 802 for providing messaging services comprising text messaging or multimedia messaging services.

In some embodiments, the list of requests indicates the requests that other registered users have sent to the requesting user while the list of requests is identified based at least in part upon one or more criteria or preferences selected by the requesting user. In one or more embodiments, the process or module 414 may respectively comprise the process or hardware module 818 for receiving and presenting a video date request. In some embodiments, the process or module 414 may use a pop-up window or an icon to notify the requesting user of the incoming video date request. In one or more embodiments, the process or module 414 may respectively comprise the process or hardware module 820 for presenting a list of options to the requesting user with respect to the request.

In some embodiments, the list of options includes accepting the request, declining the request, placing the request on hold without declining the request (e.g., when the requesting user is to identify additional information or data about the sending user of a particular request), or rescheduling the request to some other date or time. In one or more embodiments, the process or module 414 may respectively comprise the process or hardware module 822 for presenting additional data about the sending user of a particular request. In some embodiments, the additional data may include statistical data about the sending user such as whether the sending user has been reported as a concern, whether the sending user has been blocked, etc. In some embodiments, the additional data may include the matching confidence level or some historical data about the sending user, or prior dealings between the sending user and the requesting user.

It shall be noted that in some embodiments, a requesting user represents a registered user that is handling a computing device to access various modules of the online video dating products or services and does not necessarily indicate a registered user who requests for a video date or for a profile, etc. In one or more embodiments, the process or module 414 may respectively comprise the process or hardware module 824 for determining whether the participating users agree to simultaneous video dates with more than two participating users. In one or more embodiments, the process or module 414 may respectively comprise the process or hardware module 826 for identifying an input from a participating user to determine whether one or more measures or one or more preferences are to be implemented for the video date. In one or more embodiments, the process or module 414 may respectively comprise the process or hardware module 828 for providing messaging services during the video date session.

FIG. 8B illustrates an exemplary user interface for the flow diagram illustrated in FIG. 8A in some embodiments. The exemplary user interface includes a “Back” button 806D which, when clicked upon, brings back the immediate previous screen or the main menu. The exemplary user interface includes a list of potential candidates for video date 802B. Each potential candidate for video date is associated with a profile picture, his or her motto, and some brief data. Each potential candidate is also associated with a radio button 808B which the requesting user may click on to select a particular potential candidate. The exemplary user interface includes additional buttons 804B to invoke additional functions such as delete a specific candidate, reporting a particular user as a concern, or blocking/unblocking a particular user.

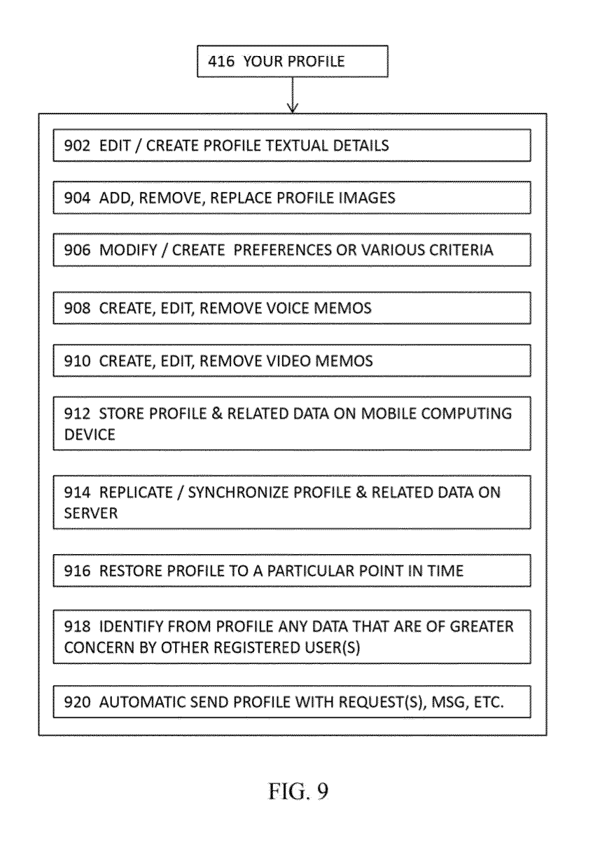

FIG. 9 illustrates more details for the high level flow diagram illustrated in FIG. 4 in some embodiments. In some embodiments, the process or module 416 may respectively comprise the process or hardware module 902 for creating or editing textual details. In some embodiments, the textual details include personal information about the requesting user, motto, etc. In some embodiments, the process or module 416 may respectively comprise the process or hardware module 904 for adding, removing, or replacing one or more profile images. In some embodiments, a profile image is not necessarily a photograph of the requesting user and may constitute a clip art or any images although the online dating products or services may nonetheless perform face recognition of profile pictures, together with one or more other anti-spam techniques (e.g., checksum-based filtering, challenge/response system, HELO/EHLO checking, hybrid filtering, pattern detection, statistical content filtering, etc.) to detect and prevent electronic spam.

In some embodiments, the process or module 416 may respectively comprise the process or hardware module 906 for creating or modifying one or more preferences or one or more criteria for, for example but not limited to, “find a date”, “video date”, etc. In some embodiments, the process or module 416 may respectively comprise the process or hardware module 908 for creating, editing, or removing voice memos that may be used to introduce the requesting user or to provide voice over in a request to add some personal touch to online dating in some embodiments. In some embodiments, the process or module 416 may respectively comprise the process or hardware module 910 for creating, editing, or removing video messages that may be used to introduce the requesting user or to provide a short video clip in or together with a request to add some personal touch to online dating in some embodiments. In some embodiments, the process or module 416 may respectively comprise the process or hardware module 912 for storing the profile or related data.

In some embodiments, the profile or related data are first stored on the computing device of the requesting user and may be duplicated on a server by synchronization in various formats. In some embodiments, the profile or related data may be associated with the requesting user and stored on the server directly without storing duplicated copies on the computing device. In some embodiments, the requesting user has control over where to store the profile and related data. In some embodiments, the profile and related data are stored in a format that may be indexed and queried by, for example, database queries. In some embodiments, the process or module 416 may respectively comprise the process or hardware module 914 for replicating or synchronizing the profile or related data on a server. In some embodiments, the process or module 416 may respectively comprise the process or hardware module 916 for restoring the profile or related data on a computing device to a point in time by using, for example, various forms of log records such as undo logs, redo logs, state logs, etc. or snapshots of the profile, which represent the entire state of a part of a database storing the requesting user's profile or related data.

For example, the user may roll back the profile or related data to a fixed point in time without having to storing multiple versions of the profile or related data in any data structures on the computing device or on the server. In some embodiments, the process or module 416 may respectively comprise the process or hardware module 918 for identifying from the profile any data that may be of greater concern by a significant number of registered users. For example, the method or system may perform statistical analyses and find that 79% of registered users in the Bay Area of California disparage “smokers”, while only 12% of registered users in Japan have the same issue with “smokers”. The method or system may provide such information as a hint or recommendation to a registered user who originated from or is currently near the Bay Area (e.g., by GPS data) that the registered user's list of potential dates contains some smokers even though the registered user does not particularly specify “smoker” as a prohibited attribute for potential dates. In some embodiments, the process or module 416 may respectively comprise the process or hardware module 920 for automatically sending a profile with a request or a message at the choice of the requesting user.

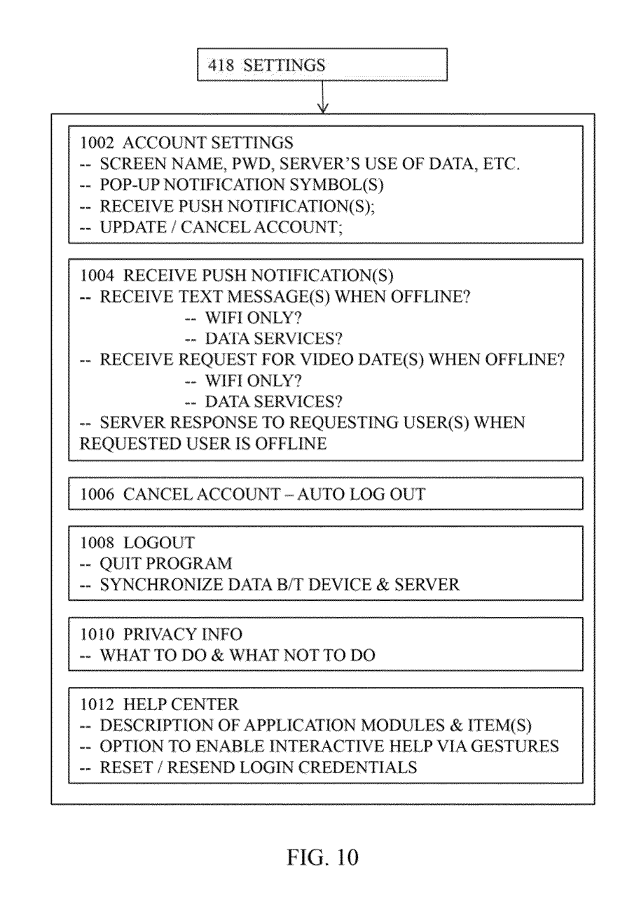

FIG. 10 illustrates more details for the high level flow diagram illustrated in FIG. 4 in some embodiments. In some embodiments, the settings module 418 may comprise the module 1002 for setting up or updating account settings. In some embodiments, the account settings may include, for example but not limited to, screen name, password, whether to allow the server to collect statistics for analyses purposes, whether to allow symbols or pop-up windows for notifications (e.g., for requests, incoming messages, etc.), whether the requesting user would like to receive push notifications, update account, or cancel account, etc. In some embodiments, the settings module 418 may comprise the module 1004 for the options of whether to receive push notifications. The options may include receiving text messages when the requesting user is offline, and whether to use Wi-Fi only, wireless data services, a combination of Wi-Fi and wireless data services, or “don't care”.

The options may include whether to receive video data requests when the requesting user is offline, and whether to use Wi-Fi only, wireless data services, a combination of Wi-Fi and wireless data services, or “don't care”. The option may also include setting automated server response to the registered users who sent various forms of requests or messages to the requesting user when the requesting user is offline. In some embodiments, the settings module 418 may comprise the module 1006 for canceling the account. When a registered user cancels his or her account, the registered user is automatically logged out of the online dating products or services and is further brought back to either a review screen to answer some questionnaires or review or a create account screen.

In some embodiments, the settings module 418 may comprise the module 100 for logging out the requesting user with the additional options of setting up one or more daemon processes to run in the background after the requesting user logs out, whether the requesting user is to receive push notifications, and whether to synchronize the data on the computing device and server(s). In some embodiments, the settings module 418 may comprise the module 1010 for presenting privacy information which may include what a registered user may do and what a registered user may not do. In some embodiments, the settings module 418 may comprise the module 1012 for providing help to registered users. The “help center” may provide description to each item in the user interface and may also provide interactive help via, for example, gestures. For example, a user may enable interactive help and click on a specific item on the screen of the computing device with a certain gesture or a simple click, the method or system may then display the help content for that specific item.

### System Architecture Overview

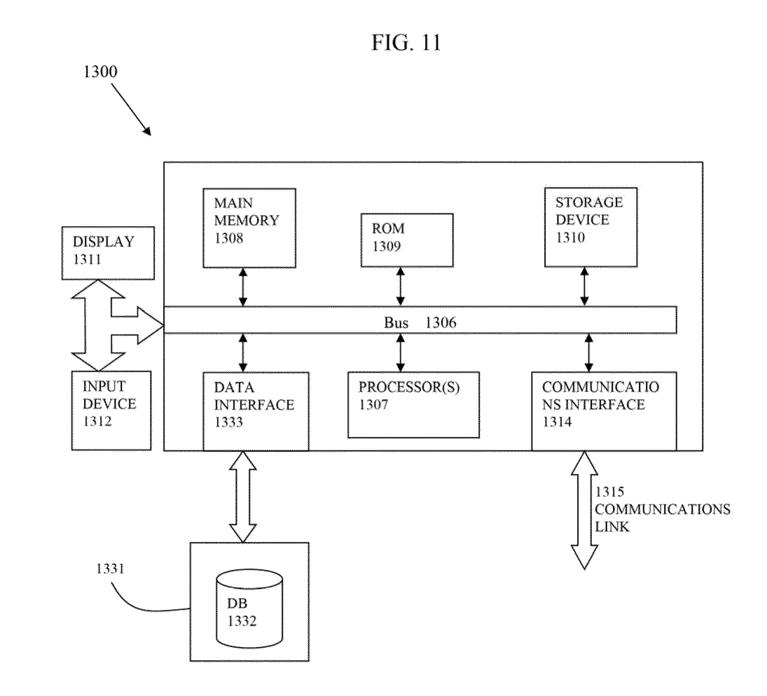

FIG. 11 illustrates a block diagram of an illustrative computing system 1300 suitable for implementing some embodiments of the invention. For example, the exemplary computing system 1300 may be used to implement various processes as described in the preceding paragraphs and the figures such as various processes or modules of making determinations or performing analyses as described in the remainder of the Application. Computer system 1300 includes a bus 1306 or other communication mechanism for communicating information, which interconnects subsystems and devices, such as processor 1307, system memory 1308 (e.g., RAM), static storage device 1309 (e.g., ROM), disk drive 1310 (e.g., magnetic or optical), communication interface 1314 (e.g., modem or Ethernet card), display 1311 (e.g., CRT or LCD), input device 1312 (e.g., keyboard), and cursor control (not shown).

According to one embodiment of the invention, computer system 1300 performs specific operations by one or more processors or processor cores 1307 executing one or more sequences of one or more instructions contained in system memory 1308. Such instructions may be read into system memory 1308 from another computer readable/usable storage medium, such as static storage device 1309 or disk drive 1310. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention. In the single embodiment or in some embodiments, the one or more processors or processor cores 1307 may be used to perform various actions such as various actions, processes, or modules involving determining, analyzing, performing actions, etc. In some embodiments, at least one of the one or more processors or processor cores 1307 has the multithreading capability.

In one embodiment, the term “logic” shall mean any combination of software or hardware that is used to implement all or part of the invention. In the single embodiment or in some embodiments, the one or more processors or processor cores 1307 may be used to perform various acts such as various acts involving determining, analyzing, performing actions, etc. In some embodiments, at least one of the one or more processors or processor cores 1307 has the multithreading capability to execute a plurality of threads to perform various tasks as described in the preceding sections.

Various actions as described in the preceding paragraphs may be performed by using one or more processors, one or more processor cores, or combination thereof 1307. For example, various processes or modules involving the determining action, various analysis processes or modules, etc. may be performed by one or more processors, one or more processor cores, or combination thereof.

The term “computer readable storage medium” or “computer usable storage medium” as used herein refers to any non-transitory medium that participates in providing instructions to processor 1307 for execution. Such a medium may take many forms, including but not limited to, non-volatile media and volatile media. Non-volatile media includes, for example, optical or magnetic disks, such as disk drive 1310. Volatile media includes dynamic memory, such as system memory 1308.

Common forms of computer readable storage media includes, for example, electromechanical disk drives (such as a floppy disk, a flexible disk, or a hard disk), a flash-based, RAM-based (such as SRAM, DRAM, SDRAM, DDR, MRAM, etc.), or any other solid-state drives (SSD), a magnetic tape, any other magnetic or a magneto-optical medium, CD-ROM, any other optical medium, punch cards, paper tape, any other physical medium with patterns of holes, RAM, PROM, EPROM, FLASH-EPROM, any other memory chip or cartridge, or any other medium from which a computer can read. For example, the various forms of computer readable storage media may be used by the methods or the systems to store either temporarily or permanently information or data such as the one or more master regions, one or more master output layers, one or more global scratch layers, various transforms and inverse transforms, shapes, etc.

In an embodiment of the invention, execution of the sequences of instructions to practice the invention is performed by a single computer system 1300. According to other embodiments of the invention, two or more computer systems 1300 coupled by communication link 1315 (e.g., LAN, PTSN, or wireless network) may perform the sequence of instructions required to practice the invention in coordination with one another.

Computer system 1300 may transmit and receive messages, data, and instructions, including program, i.e., application code, through communication link 1315 and communication interface 1314. Received program code may be executed by processor 1307 as it is received, and/or stored in disk drive 1310, or other non-volatile storage for later execution. In an embodiment, the computer system 1300 operates in conjunction with a data storage system 1331, e.g., a data storage system 1331 that contains a database 1332 that is readily accessible by the computer system 1300. The computer system 1300 communicates with the data storage system 1331 through a data interface 1333. A data interface 1333, which is coupled to the bus 1306, transmits and receives electrical, electromagnetic or optical signals that include data streams representing various types of signal information, e.g., instructions, messages and data. In embodiments of the invention, the functions of the data interface 1333 may be performed by the communication interface 1314.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer implemented method for implementing online video date, comprising:
using a computing device which comprises at least one processor to perform a process, the process comprising:
identifying a list of criteria of a requesting user;
identifying a list of characteristics about the requesting user;
presenting a list of one or more potential dates to the requesting user; and
providing a video date between the requesting user and a potential date in the list of one or more potential dates on the computing device.

2. The computer implemented method of claim 1, in which the act of presenting the list to the requesting user comprises:
determining whether to place a registered user on the list of one or more potential dates by examining data about the registered user based at least in part upon the list of criteria; and
determining the list of one or more potential dates by examining a plurality of registered users in a data structure.

3. The computer implemented method of claim 2, in which the act of presenting the list to the requesting user further comprises:
determining whether to place the registered user on the list of one or more potential dates by examining the data based further in part upon the list of characteristics of the requesting user.

4. The computer implemented method of claim 3, in which the act of presenting the list to the requesting user further comprises:
determining whether to place the registered user on the list of one or more potential dates by examining the list of characteristics about the requesting user based at least in part upon a first list of characteristics of the registered user.

5. The computer implemented method of claim 1, the process further comprising:
identifying relevant data from a similar user who is similarly situated as the requesting user; and
identifying the list of one or more potential dates based further in part upon the relevant data.

6. The computer implemented method of claim 1, the process further comprising at least one of:
implementing a security measure on a video stream of data for the video date;
synchronizing data for the requesting user on the computing device and a server;
restoring the data for the requesting user on the computing device to a version created at a fixed point in time without storing multiple versions of the data on the computing device or on the server; and
determining a recommendation for the requesting user about the potential date or for the potential data about the requesting user.

7. The computer implemented method of claim 1, in which
there exist no prior contact or prior relationships between the requesting user and the potential date, and
the computing device comprises a mobile computing device.

8. An article of manufacture comprising a non-transitory computer readable storage medium storing thereupon a sequence of instructions which, when executed by at least one processor or at least one processor core, causes the at least one processor or the at least one processor core to perform a method for implementing online video date, the method comprising:
using the at least one processor to perform a process, the process comprising:
identifying a list of criteria of a requesting user;
identifying a list of characteristics about the requesting user;
presenting a list of one or more potential dates to the requesting user;
providing a video date between the requesting user and a potential date in the list of one or more potential dates on the computing device.

9. The article of manufacture of claim 8, in which the act of presenting the list to the requesting user comprises:
determining whether to place a registered user on the list of one or more potential dates by examining data about the registered user based at least in part upon the list of criteria; and
determining the list of one or more potential dates by examining a plurality of registered users in a data structure.

10. The article of manufacture of claim 9, in which the act of presenting the list to the requesting user further comprises:
determining whether to place the registered user on the list of one or more potential dates by examining the data based further in part upon the list of characteristics of the requesting user.

11. The article of manufacture of claim 10, in which the act of presenting the list to the requesting user further comprises:
determining whether to place the registered user on the list of one or more potential dates by examining the list of characteristics about the requesting user based at least in part upon a first list of characteristics of the registered user.

12. The article of manufacture of claim 8, the process further comprising:
identifying relevant data from a similar user who is similarly situated as the requesting user; and
identifying the list of one or more potential dates based further in part upon the relevant data.

13. The article of manufacture of claim 8, the process further comprising at least one of:
implementing a security measure on a video stream of data for the video date;
synchronizing data for the requesting user on the computing device and a server;
restoring the data for the requesting user on the computing device to a version created at a fixed point in time without storing multiple versions of the data on the computing device or on the server; and
determining a recommendation for the requesting user about the potential date or for the potential data about the requesting user.

14. The article of manufacture of claim 8, in which
there exist no prior contact or prior relationships between the requesting user and the potential date, and
the computing device comprises a mobile computing device.

15. A system for implementing online video date, comprising:
a computing device that comprises at least one processor and is to:
identify a list of criteria of a requesting user;
identify a list of characteristics about the requesting user;
present a list of one or more potential dates to the requesting user; and
provide a video date between the requesting user and a potential date in the list of one or more potential dates on the computing device.

16. The system of claim 15, in which the computing device that is to present the list to the requesting user is further to:
determine whether to place a registered user on the list of one or more potential dates by examining data about the registered user based at least in part upon the list of criteria; and
determine the list of one or more potential dates by examining a plurality of registered users in a data structure.

17. The system of claim 16, in which the computing device that is to present the list to the requesting user is further to:
determine whether to place the registered user on the list of one or more potential dates by examining the data based further in part upon the list of characteristics of the requesting user; and
determine whether to place the registered user on the list of one or more potential dates by examining the list of characteristics about the requesting user based at least in part upon a first list of characteristics of the registered user.

18. The system of claim 15, the computing system is further to:
identify relevant data from a similar user who is similarly situated as the requesting user; and
identify the list of one or more potential dates based further in part upon the relevant data.

19. The system of claim 15, the computing system is further to:
implement a security measure on a video stream of data for the video date;
synchronize data for the requesting user on the computing device and a server;
restore the data for the requesting user on the computing device to a version created at a fixed point in time without storing multiple versions of the data on the computing device or on the server; or
determine a recommendation for the requesting user about the potential date or for the potential data about the requesting user.

20. The system of claim 15, in which there exist no prior contact or prior relationships between the requesting user and the potential date.
